(19) United States
(12) Patent Application Publication
(10) Pub. No.: US 2012/0179570 A1
(43) Pub. Date: Jul. 12, 2012

(54) Total Cost Management System, Method, and Apparatus

(75) Inventors: William R. Blair, Gibsonia, PA (US); John D. Benzinger, Valencia, PA (US); Venkata Paparao Gummadapu, Wexford, PA (US); Steven E. Figore, Pittsburgh, PA (US); Joseph R. Price, Pittsburgh, PA (US)

(73) Assignee: Co-eXprise, Inc., Wexford, PA (US)

(21) Appl. No.: 12/986,643

(22) Filed: Jan. 7, 2011

(51) Int. Cl. G06Q 30/00; G06F 3/048

(52) U.S. Cl. 705/26.4; 715/810

(57) ABSTRACT

A total cost management system including a user interface having: (i) selectable options to facilitate building a total cost template including at least one section having a plurality of variables associated therewith; (ii) selectable options to facilitate at least one of the following: creating, deleting, manipulating, configuring, changing, modifying, moving, or any combination thereof, at least one of the at least one section and at least one of the plurality of variables; and (iii) selectable options to define at least one total cost unit price for: at least one item, at least one group of items, at least one assembly, at least one group of assemblies, at least one sub-assembly, at least one group of sub-assemblies, at least one lot, and/or at least one service wherein the at least one total cost unit price is defined by a formula including a plurality of the variables in at least one section.

### BACKGROUND OF THE INVENTION

1. Field of the Invention

The present invention relates generally to negotiation events between buyers and suppliers and/or sellers, such as a sourcing event between a buyer and multiple suppliers, and in particular, to a system, method, and apparatus for building, initiating, and facilitating a total cost-based event for a buyer to evaluate one or more suppliers.

2. Description of the Related Art

In order to purchase items, assemblies, sub-assemblies, services, and the like, a buyer may ask that multiple suppliers or providers make an offer to provide such items, assemblies, sub-assemblies and/or services. By engaging in such an event or negotiation, the buyer can determine the best supplier or provider for the buyer's needs.

Certain systems and methods exist for engaging in such a transaction or negotiation. However, such systems are used for determining a simple unit cost for the item, assembly, sub-assembly, and/or service based upon specific known variables. The buyer then obtains or determines this unit cost from each supplier and, initially, compares the various unit costs to determine the best supplier for the item, assembly, sub-assembly, and/or service. However, this standard unit cost only provides one specific metric for determining the best supplier in any particular negotiation or event, such as an auction, an electronic request for quotation, and RFx-event, or the like. There are many other factors that are normally considered by a buyer in making a final decision as to which supplier best suits their needs. For example, the lower standard unit price is not always the most cost effective to the buyer. Instead, many other factors should be taken into consideration, such as duties, freight, customs, packaging, inventory, etc. Accordingly, there is a need in the art for a system, method, and apparatus that provides at least one total cost unit price that takes these and other factors into consideration.

As also known in the prior art, when a buyer desires multiple suppliers to bid or quote an item, assembly, sub-assembly, and/or service, a request for quotation (RFQ) is generated and provided to each supplier. The supplier reviews the RFQ and completes some or all of the requests in the RFQ and sends it back to the buyer for review and consideration. While this effectively provides the supplier's information to the buyer, it does not ensure that each supplier is providing all the information that a buyer needs to make a decision. For example, if the supplier fails to complete or provide a response to a particular variable of the RFQ, the buyer may not be able to make an appropriate determination.

Still further, when the buyer supplies the RFQ to the suppliers, such as in a spreadsheet or word processor format, the control over the RFQ is lost. In particular, if the RFQ is in a format that is modifiable by the supplier, the settings or organization of certain variables or inputs may be changed by a specific supplier in the response to the RFQ. This may lead to the inability of a buyer to properly compare suppliers on a consistent basis, since the modification by one supplier is not translated to another supplier. In this manner, the buyer cannot determine the “best” supplier.

The purpose of any buyer's request for quotation, auction, or similar request to negotiate is to find the best value for any particular items, assemblies, sub-assemblies, services, and the like. However, how each buyer determines what is “best” for their organization from a purchasing standpoint varies from buyer to buyer. For example, one buyer may place more emphasis on the lowest standard cost on a per unit basis regardless of the supplier, while another buyer may place more emphasis on using a preexisting supplier, the freight terms, the recurring costs, or the like, even if the standard unit cost is slightly higher. Therefore, there is a need to provide each buyer with the opportunity to not only ask the right questions of each supplier, but to consistently evaluate the returned information to make the appropriate decision. In order to achieve this, there is a need in the art to provide a total cost management system that allows for complete flexibility and customization for each specific buyer, as well as standardization of total cost analyses across all buyers within a given commodity, region, business unit, and/or organization.

In addition, and according to existing systems, the suppliers submit the entire set of information in response to the request. The buyer must then sort through the entire body of information and data in order to make the appropriate decision and supplier selection. However, such a process does not take in to account that, in order to make a “total cost” decision, the buyer may need certain information from the supplier and/or ask additional questions. Therefore, there is a further need in the art for a total cost management system that facilitates the creation of a total cost template or request that facilitates certain intermediate determinations and decisions before final selection.

### SUMMARY OF THE INVENTION

Therefore, the present invention generally provides a total cost system, method, and apparatus that addresses and/or overcomes some or all of the deficiencies of existing cost management and quotation systems. Preferably, the present invention provides a total cost system, method, and apparatus that determine at least one total cost unit price that takes various factors into consideration. Preferably, the present invention provides a total cost system, method, and apparatus that ensure that the buyer receives the appropriate information and data to make the appropriate decision. Preferably, the present invention provides a total cost system, method, and apparatus that effectively control the supplier response process. Preferably, the present invention provides a total cost system, method, and apparatus that provide complete flexibility and customization for each specific buyer or groups of buyers. Preferably, the present invention provides a total cost system, method, and apparatus that facilitate the creation of a total cost worksheet or request that allow for certain intermediate determinations and decisions before final selection.

Therefore, and according to one preferred and non-limiting embodiment, provided is a total cost management system including a user interface having: (i) a plurality of selectable options to facilitate building at least one total cost template including at least one section having a plurality of variables associated therewith; (ii) a plurality of selectable options to facilitate at least one of the following: creating, deleting, manipulating, configuring, changing, modifying, moving, or any combination thereof, at least one of the at least one section and at least one of the plurality of variables; and (iii) at least one selectable option to define at least one total cost unit price for at least one of the following: at least one item, at least one group of items, at least one assembly, at least one group of assemblies, at least one sub-assembly, at least one group of sub-assemblies, at least one lot, at least one service, or any combination thereof; wherein the at least one total cost unit price is defined by a formula including a plurality of the plurality of variables in the at least one section.

According to another preferred and non-limiting embodiment, provided is a computer-implemented method for initiating a total cost event between at least one buyer and at least one supplier. The method includes: defining at least one parameter of the total cost event; selecting at least one total cost template having at least one section including a plurality of variables associated therewith, the at least one total cost template associated with at least one of the following: at least one item, at least one group of items, at least one assembly, at least one group of assemblies, at least one sub-assembly, at least one group of sub-assemblies, at least one lot, at least one service, or any combination thereof; selecting at least one supplier for participation in the total cost event; initiating the total cost event by presenting at least a portion of the plurality of variables to the at least one supplier; wherein the total cost event is associated with at least one total cost unit price for at least one of the following: at least one item, at least one group of items, at least one assembly, at least one group of assemblies, at least one sub-assembly, at least one group of sub-assemblies, or any combination thereof and wherein the at least one total cost unit price is defined by a formula including a plurality of the plurality of variables in the at least one section.

According to a further preferred and non-limiting embodiment, provided is a computer-implemented method of facilitating a total cost event between at least one buyer and at least one supplier. The method includes: transmitting, to the at least one supplier, at least one total cost template having at least one section including a plurality of variables associated therewith, the at least one total cost template associated with at least one of the following: at least one item, at least one group of items, at least one assembly, at least one group of assemblies, at least one sub-assembly, at least one group of sub-assemblies, at least one lot, at least one service, or any combination thereof, wherein the total cost event is associated with at least one total cost unit price for at least one of the following: at least one item, at least one group of items, at least one assembly, at least one group of assemblies, at least one sub-assembly, at least one group of sub-assemblies, or any combination thereof and wherein the at least one total cost unit price is defined by a formula including a plurality of the plurality of variables in the at least one section; receiving at least one at least partially completed total cost template from the at least one supplier; and generating at least one configurable view presenting at least one of the plurality of variables as completed by the at least one supplier.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram of a computer system according to the prior art for use in connection with a total cost management system, method, and apparatus according to the principles of the present invention;

FIG. 2 is a schematic view of one embodiment of a total cost management system, method, and apparatus according to the principles of the present invention;

FIGS. 3-54 are screenshots of certain functional portions and outputs of one preferred embodiment of a total cost management system, method, and apparatus according to the principles of the present invention.

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

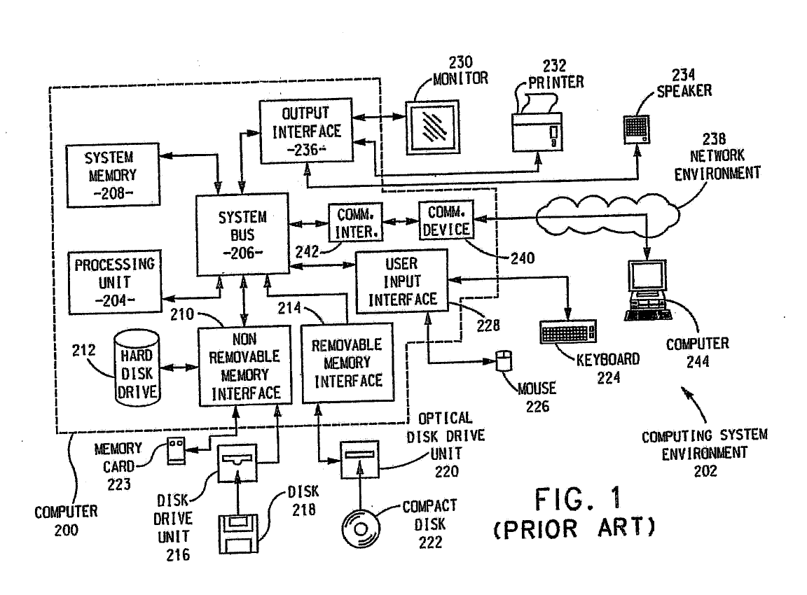

The present invention may be implemented on a variety of computing devices and systems, wherein these computing devices include the appropriate processing mechanisms and computer-readable media for storing and executing computer-readable instructions, such as programming instructions, code, and the like. As illustrated in FIG. 1 and according to the prior art, a schematic and block diagram of exemplary computing devices, in the form of personal computers 200, 244, in a computing system environment 202 are provided. This computing system environment 202 may include, but is not limited to, at least one computer 200 having certain components for appropriate operation, execution of code, and creation and communication of data. For example, the computer 200 includes a processing unit 204 (typically referred to as a central processing unit or CPU) that serves to execute computer-based instructions received in the appropriate data form and format. Further, this processing unit 204 may be in the form of multiple processors executing code in series, in parallel, or in any other manner for appropriate implementation of the computer-based instructions.

In order to facilitate appropriate data communication and processing information between the various components of the computer 200, a system bus 206 is utilized. The system bus 206 may be any of several types of bus structures, including a memory bus or memory controller, a peripheral bus, or a local bus using any of a variety of bus architectures. In particular, the system bus 206 facilitates data and information communication between the various components (whether internal or external to the computer 200) through a variety of interfaces, as discussed hereinafter.

The computer 200 may include a variety of discrete computer-readable media components. For example, this computer-readable media may include any media that can be accessed by the computer 200, such as volatile media, non-volatile media, removable media, non-removable media, etc. As a further example, this computer-readable media may include computer storage media, such as media implemented in any method or technology for storage of information such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 200. Further, this computer-readable media may include communications media, such as computer-readable instructions, data structures, program modules, or other data in a modulated data signal such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 200 further includes a system memory 208 with computer storage media in the form of volatile and non-volatile memory, such as ROM and RAM. A basic input/output system (BIOS) with appropriate computer-based routines assists in transferring information between components within the computer 200 and is normally stored in ROM. The RAM portion of the system memory 208 typically contains data and program modules that are immediately accessible to or presently being operated on by processing unit 204, e.g., an operating system, application programming interfaces, application programs, program modules, program data, and other instruction-based computer-readable code.

The computer 200 may also include other removable or non-removable, volatile or non-volatile computer storage media products. For example, the computer 200 may include a non-removable memory interface 210 that communicates with and controls a hard disk drive 212, i.e., a non-removable, non-volatile magnetic medium; and a removable, non-volatile memory interface 214 that communicates with and controls a magnetic disk drive unit 216 (which reads from and writes to a removable, non-volatile magnetic disk 218), an optical disk drive unit 220 (which reads from and writes to a removable, non-volatile optical disk, such as a CD ROM 222), a Universal Serial Bus (USB) port for use in connection with a removable memory card 223, etc. However, it is envisioned that other removable or non-removable, volatile or non-volatile computer storage media can be used in the exemplary computing system environment 202, including, but not limited to, magnetic tape cassettes, DVDs, digital video tape, solid state RAM, solid state ROM, etc. These various removable or non-removable, volatile or non-volatile magnetic media are in communication with the processing unit 204 and other components of the computer 200 via the system bus 206. The drives and their associated computer storage media discussed above and illustrated in FIG. 1 provide storage of operating systems, computer-readable instructions, application programs, data structures, program modules, program data, and other instruction-based computer-readable code for the computer 200 (whether duplicative or not of the information and data in the system memory 208).

A user may enter commands, information, and data into the computer 200 through certain attachable or operable input devices, such as a keyboard 224, a mouse 226, etc., via a user input interface 228. Of course, a variety of such input devices may be utilized, e.g., a microphone, a trackball, a joystick, a touchpad, a touch-screen, a scanner, etc., including any arrangement that facilitates the input of data and information to the computer 200 from an outside source. As discussed, these and other input devices are often connected to the processing unit 204 through the user input interface 228 coupled to the system bus 206, but may be connected by other interface and bus structures, such as a parallel port, game port, or a USB. Still further, data and information can be presented or provided to a user in an intelligible form or format through certain output devices, such as a monitor 230 (to visually display this information and data in electronic form), a printer 232 (to physically display this information and data in print form), a speaker 234 (to audibly present this information and data in audible form), etc. All of these devices are in communication with the computer 200 through an output interface 236 coupled to the system bus 206. It is envisioned that any such peripheral output devices be used to provide information and data to the user.

The computer 200 may operate in a network environment 238 through the use of a communications device 240, which is integral to the computer or remote therefrom. This communications device 240 is operable by and in communication with the other components of the computer 200 through a communications interface 242. Using such an arrangement, the computer 200 may connect with or otherwise communicate with one or more remote computers, such as a remote computer 244, which may be a personal computer, a server, a router, a network personal computer, a peer device, or other common network node, and typically includes many or all of the components described above in connection with the computer 200. Using appropriate communications devices 240, e.g., a modem, a network interface, or adapter, etc., the computer 200 may operate within and communicate through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 200, 244 may be used.

As used herein, the computer 200 includes or is operable to execute appropriate custom-designed or conventional software to perform and implement the processing steps of the method and system of the present invention, thereby forming a specialized and particular computing system. Accordingly, the presently-invented method and system may include one or more computers 200 or similar computing devices having a computer-readable storage medium capable of storing computer-readable program code or instructions that cause the processing unit 204 to execute, configure, or otherwise implement the methods, processes, and transformational data manipulations discussed hereinafter in connection with the present invention. Still further, the computer 200 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system. In addition, the inventive method and system may be in the form of an article including a machine-readable storage medium containing instructions that, if executed, enable a processor to execute, configure, or otherwise implement the methods, processes and transformational data manipulations discussed hereinafter in connection with the present invention.

The present invention is directed to a total cost management system, method, and apparatus that can be implemented and used in a variety of negotiation and cost management applications. Further, the present invention can be implemented on a personal computer 200, 244 and in a computing system environment 202. When implemented in the context of hardware, the present invention is in the form of program instructions that can be implemented through the appropriate input and output of data through the computer 200, 244, thus making the computer 200, 244 a specially-programmed apparatus for facilitating operation of the present invention. Still further, the presently-invented total cost management system and method can be further facilitated through wired or wireless communications between multiple computers 200, 244 in the network environment 238 to provide appropriate functionality for effective communication. The total cost management system and method of the present invention may also be in the form of custom-designed or conventional software to perform and implement the processing steps, again which provides a specialized and particular computing system. In addition, the presently-invented method and system may be provided on some computer-readable storage medium or as an article for distribution, such as a compact disc, tape, USB card, memory card, or the like.

In order to facilitate user interaction and otherwise allow for the appropriate usage of the present invention, the functional user interface 10 is presented to the user, such as an administrative user, a buyer B, a supplier S, or the like, and this user interface 10 includes multiple selectable options 12. These selectable options 12 allow the user to interface with the system through known elements, e.g., text entry boxes, drop-down menus, radio buttons, selectable lists, direct or indirect input choices, and the like. This user interface 10 is presented to the user through the above-discussed computer 200, 244, which is in communication with the monitor 230. In addition, such interaction may be through a variety of input devices, such as a keyboard 224, a mouse 226, etc.

The presently-invented total cost management system, method, and apparatus can be utilized in connection with a variety of events between buyers and sellers (or suppliers). In particular, the present invention is useful in any application or environment where a total cost approach to negotiation is beneficial. Accordingly, incorporated herein are the following pending patent applications: application Ser. No. 11/208,694 (entitled “Cost File Translation Methods, Systems, and Apparatuses for Extended Commerce”); application Ser. No. 11/209,090 (entitled “Collaborative Negotiation Methods, Systems, and Apparatuses for Extended Commerce”); application Ser. No. 11/209,091 (entitled “Supplier Capability Methods, Systems, and Apparatuses for Extended Commerce”); and application Ser. No. 12/052,263 (entitled “Method and System for Facilitating a Negotiation”); and U.S. Pat. No. 7,810,025 (entitled “File Translation Methods, Systems, and Apparatuses for Extended Commerce”).

In one preferred and non-limiting embodiment of the present invention, the user interacts with the user interface 10 (and selectable options 12) to build a total cost template 14. Once built, this template 14 can be stored for future use. In this manner, a single cost template 14 can be used for multiple negotiations and applications, and as discussed hereinafter, may be further modified to suit the particular needs of any specific situation, commodity, region, negotiation, event, or buyer B focus. Accordingly, a number of total cost templates 14 can be stored in a repository that is accessible by an authorized user. Therefore, appropriate security can be applied, such that some or all of the total cost templates 14 can be shared with a group of users that have permission to view and/or modify these templates 14. In one embodiment, these total cost templates 14 can be referred to as “sourcing” templates, as the primary environment and application of the present invention is in a negotiation or quoting process.

In this manner, the total cost management system, method and apparatus of the present invention can be used in purchasing or analyzing the total cost associated with one or more items, one or more groups of items, one or more assemblies, one or more groups of assemblies, one or more sub-assemblies, one or more groups of sub-assemblies, one or more lots, one or more services, or the like. This list is intended to include all items, goods, or services that can be sourced, including direct sourcing, indirect sourcing, materials, employment services or interactions, utilities, and other things or services of commerce. In addition, the present invention may be used in any type of project or event, where one primary goal is to determine total cost information for the user. For example, the presently-invented system, method, and apparatus may be instituted in any known event, negotiation, or analysis with the primary purpose of determining the “best” value or values for the buyer or supplier, e.g., lowest price, highest price, or any other configurable definition of “best” value or values. Accordingly, the present invention can be used in traditional negotiation events and processes, e.g., request for quotation, or auction-type events, e.g., forward or reverse auctions. Therefore, the present invention is not limited to any specific type or model event, negotiation, or analysis.

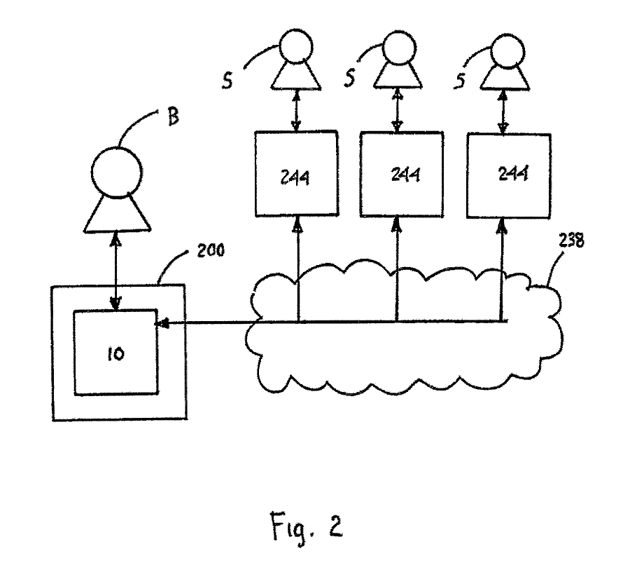

As seen in FIG. 2, the user may be a buyer B (or someone affiliated therewith) who utilizes the user interface 10 to build a total cost template 14, which is then wholly or partially provided to one or more suppliers S for quotation or completion (as discussed in detail hereinafter). Importantly, the negotiation or event may occur between two parties or between a single party and multiple parties, e.g., a single buyer and a single supplier, a single buyer and multiple suppliers, a single offeror and a single potential customer, a single offeror and multiple potential customers. While normally used in the context of a single buyer and multiple suppliers (as primarily discussed hereinafter), the present invention is equally useful in connection with an event between two, discrete entities or parties, e.g., a single buyer and single supplier. Accordingly, the terms and roles of a “buyer” and a “supplier” (as used hereinafter) are not meant to be limiting and can be interchanged with the terms and roles of a “offeror”, an “offeree”, a “seller”, a “purchaser”, a “consumer”, a “distributor”, a “retailer”, etc., depending upon the type of project or event that is implemented.

The present invention further comprises the above-discussed selectable options 12 that allow for the appropriate navigation throughout the system, as well as to facilitate the creation, deletion, manipulation, configuration, change, modification, and/or movement of data, presentations of data, graphical representations of data, and the like. Accordingly, the selectable options 12 can be in a variety of forms, as is known in the art, including, but not limited to, lists, drop-down menus, radio buttons, multiple-choice selections, direct entry, mouse selections, and similar presentations of information or data for consideration and selection by the user. For example, navigational trees can be selectively positioned on the user interface 10, and the selectable options 12 may be graphically represented by text and/or symbols that represent certain functions within the total cost management system and method.

As discussed above, existing systems and methods for sourcing are considered “standard” cost events, where a single and standard unit price is determined. However, as discussed above, there are a number of deficiencies in this approach to both the purchaser or buyer B and the suppliers S, which is addressed by the presently-invented total cost management system, method and apparatus of the present invention. In particular, through the creation of the total cost template 14 (as discussed hereinafter), a configurable and flexible total cost unit price can be determined, which represents additional pricing and costs and/or considerations (including price factors, e.g., tooling costs, switching costs, etc. and non-price factors, e.g., lead time, manufacturing capabilities, quality certifications, adherence to specifications, supplier status, shipping information, inventory information, delivery information, shifts-per-day, raw materials, etc.) not currently considered in connection with the standard unit price.

In order to derive this desired total cost unit price, the user interacts with the user interface 10 and selectable options 12 to formulaically build this total cost unit price through the use of supplier S responses to presented variables 18 and buyer-derived information and data. As discussed above, such a total cost unit price is of considerably more value in determining which supplier S or group of suppliers S the buyer B wishes to select or consider selecting. As an example, while the standard unit price is strictly the cost of the item, assembly, good, etc. (typically including material cost, equipment cost, direct labor cost, profit and overhead costs, and packaging and delivery costs), the present invention allows for a configurable total cost unit price to be defined, such as a price or cost that includes the standard unit cost, freight, duties, customs, raw materials, indirect labor costs, sales costs, administration costs, historical relationships, and the like.

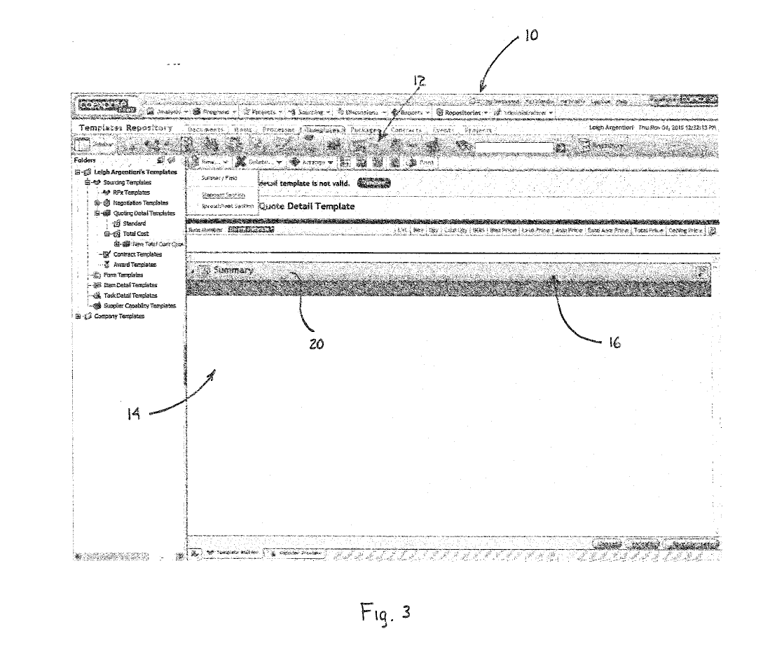

The user interface 10 provides the appropriate selectable options 12 for creating or building the total cost template 14. For example, in one preferred and non-limiting embodiment, and as illustrated in FIG. 3, the selectable options 12 allow for the creation, deletion, manipulation, configuration, change, modification, and/or movement of one or more sections 16 having multiple variables 18 associated therewith. Further, these variables 18 (alternatively referred to as “fields” or “questions”) may be a buyer-entered variable applicable to multiple suppliers S, a buyer-entered variable applicable to a specified supplier S, a supplier-entered variable, a calculated variable, a global variable, a system variable, a look-up table-based variable, a mandatory variable, a viewable variable, a post-bid variable, an external variable, an internal variable, a non-price or non-cost variable, a non-monetary variable, and/or a monetized variable.

In this embodiment, the total cost template 14 is automatically created with a summary section 20 which will eventually include the final variable or variables for presenting the “total cost” to the buyer B. In one preferred and non-limiting embodiment, the summary section 20 is mandatory, so that the buyer B has a central location of the high-level data, e.g., the total cost unit price, for facilitating the decision-making process. This summary section 20 will be discussed in detail hereinafter. In addition, and in order to provide the “total cost” variable or variables in this summary section 20, other sections 16 are first utilized.

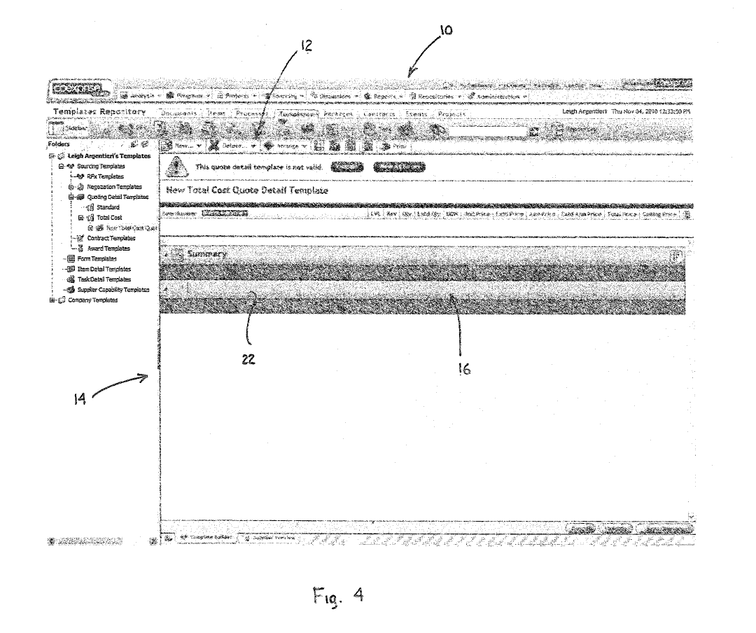

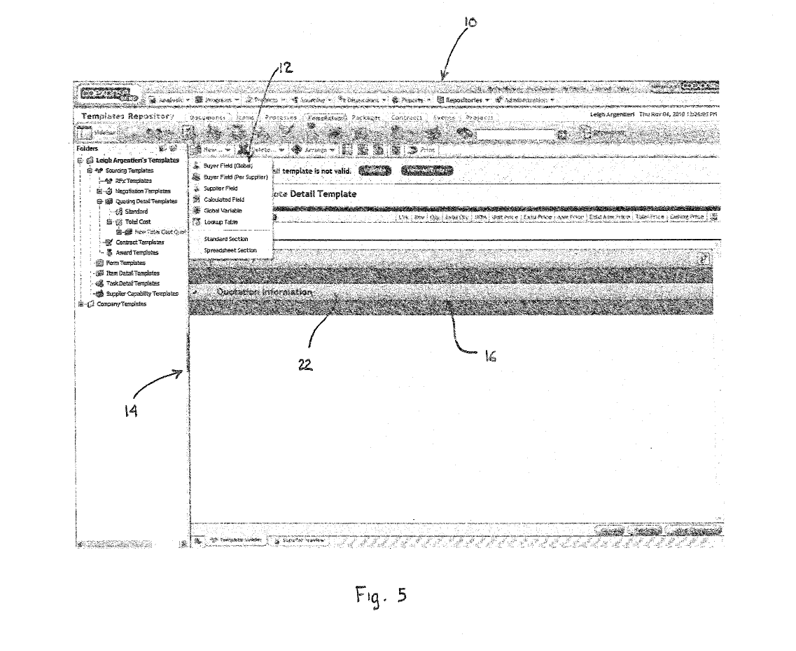

Again, and with reference to FIG. 4, in this embodiment, a standard section 22 is built. When the standard section 22 (or any section 16) is created, the user can provide a title for the section 16, which, in this embodiment, is “Quotation Information.” See FIG. 5.

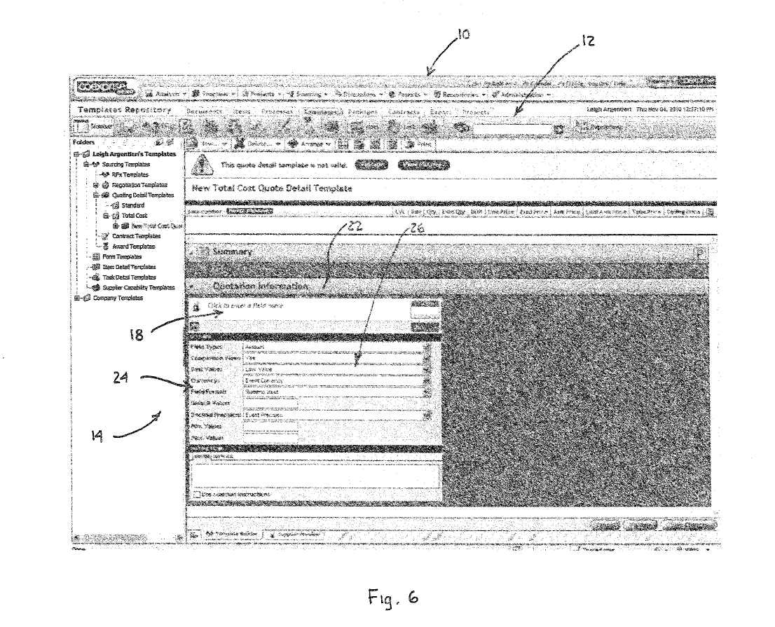

As seen in FIG. 5, once this standard section 22 is created, various variables 18 can be created or established within the section 22. As seen in this embodiment, the user can select: a global buyer field, which is a variable that is created by the buyer B and applicable to all suppliers S, a per supplier buyer field, which is created by the buyer B and applicable to specific suppliers S, a supplier field, which requires response from the supplier S, a calculated field, a global variable, and a look-up table-based variable (all of which are discussed hereinafter). As seen in FIG. 6, once the appropriate type of variable 18 (or field) is selected, such as the supplier field, a variable section 24 is created for defining all of the parameters 26 (or settings) associated with the specific variable 18. As seen in FIG. 6, the parameters 26 (or settings) can be adjusted, modified, etc. These parameters 26 can be defined through user interaction (as discussed above) and these parameters 26 may include field type, comparison view, best value, unit of measurement (e.g., weight), field format, default value, decimal precision, minimum value, maximum value, instruction text, associated document, text link, default value, or the like. In addition, these parameters 26 can facilitate the use of multiple or single choice selection or response.

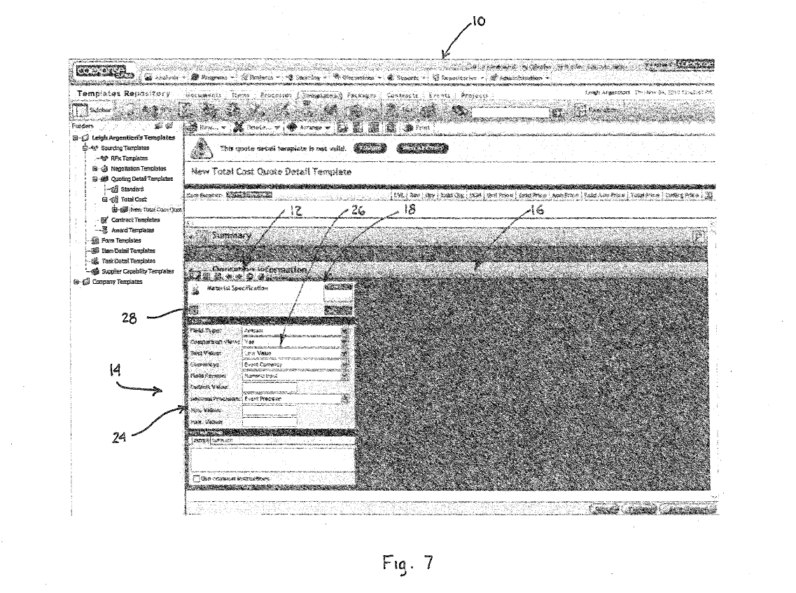

The selectable options 12 also provide the user with the ability to create, delete, manipulate, configure, change, modify, move, or otherwise interact with the section 16, variables 18, variable section 24, and other portions of the system. For example, the user can expand, collapse, or delete portions of the total cost template 14 or otherwise configure the total cost template 14 during the creation process. See FIG. 7. As discussed hereinafter, the buyer B is capable of setting which sections 16 are expanded by default.

As seen in FIG. 7, and in this embodiment, the user names the variable 18 “Material Specification,” and the available parameters include field type (which may be amount, value, percentage, text, or the like), comparison view (which provides the buyer B with the ability to make quick comparisons in the eventual analysis (or analysis portion or node) of the response data of the suppliers S), best value (such as high value, low value, etc.), unit of measurement, currency (for defining which currency will be used for the particular variable 18), field format (for defining the format of the variable 18), default value (if there is a default value associated with the variable 18), decimal precision (the accuracy of the input information), minimum value (the minimum acceptable value), maximum value (the maximum acceptable value), and instructions. The variable 18 type has built-in business logic to define their unique and/or appropriate options. The instructions may provide information, such as textual information to the buyer B for purposes of self notations and/or to the supplier S, such as instructions for completing the information in the variable section 24. Of course these instructions or textual information may be the same for both the buyer B and supplier 5, or different for the buyer B and suppliers S.

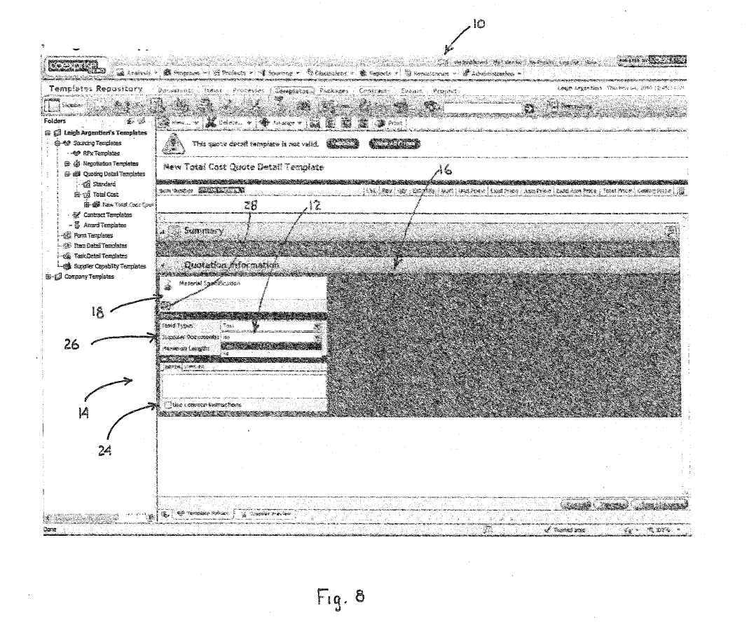

In this embodiment, and as shown in FIG. 8, this “Material Specification” variable 18 is a text-based variable, which allows the user to request the attachment of documents, which will be associated with this particular variable 18. In this example, since the variable is “Material Specification,” the attached supplier document may be a Material Safety Data Sheet (MSDS). Further, the maximum length of the text input can also be defined. Prior to creating a new variable 18 (and variable section 24), it is recommended that the user begin and continue to save the total cost template 14. Still further, within the variable section 24, and as illustrated in FIG. 8, the user can define whether or not the variable 18 is “mandatory,” i.e., each supplier S must provide information in response to this variable 18 (or question). In this embodiment, a “mandatory” button 28, e.g., a red star icon, can be toggled “on” or “off” for defining whether or not each supplier S can optionally respond or must respond with information regarding the variable 18.

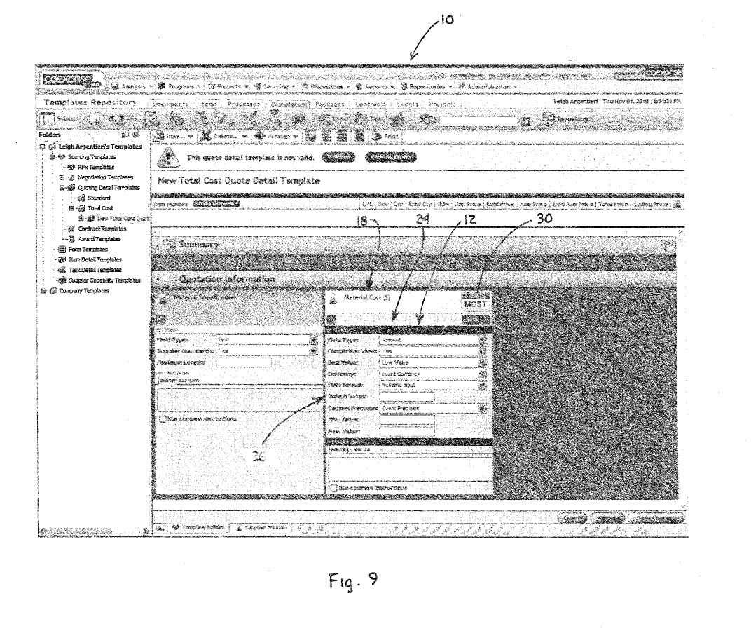

FIG. 9 illustrates another unique aspect and preferred and non-limiting embodiment of the present invention. In particular, a new variable 18 (and variable section 24) is created and labeled “Material Cost.” As discussed above, the various parameters 26 can be modified for any variable 18 created. However, for this particular variable 18, i.e., “Material Cost,” the user anticipates using this information when defining the above-discussed total cost unit price. Accordingly, and in order to allow this responsive data to be effectively utilized in a hierarchical manner, a symbol 30 is assigned to this variable 18. This symbol 30 can be textual (as is shown), or graphically represented in any similar manner, such as through the use of characters, symbols, and the like. Once created and assigned a symbol 30, this variable 18 can be used extensively and on an ongoing basis as the user continues to create the total cost template 14. Accordingly, by defining a unique symbol 30 for certain variables 18, the buyer B can be consistent and effectively use all of the information at his or her disposal when evaluating responses from the suppliers S. Further, the symbol 30 provides a quick mental reminder of the data associated with the variable 18, which allows for easier use in defining variables 18 that are calculated or equation-based (as discussed hereinafter).

It should be noted that certain parameters 26 not only assist in defining the variable 18, but also restrict or automatically determine responses from supplier S. For example, the default value may be the information, e.g., shifts per day, that is entered for this parameter 26 unless the supplier S specifies otherwise. Similarly, the minimum value and maximum value restrict the supplier S from entering information or data outside of these limits. Accordingly, and in another unique aspect of the present invention, through the definition of these parameters 26, the user or buyer B can restrict or complete information from the supplier 5, which ultimately provides more control over the entire process.

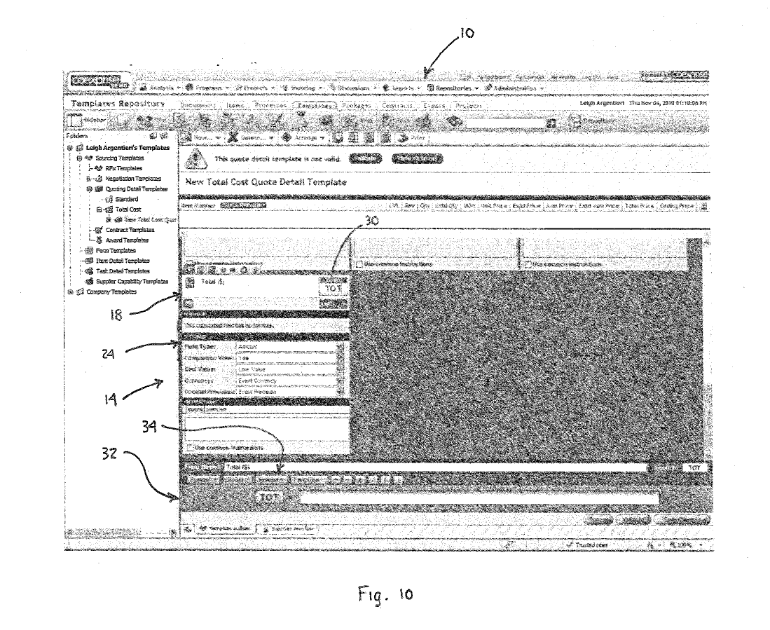

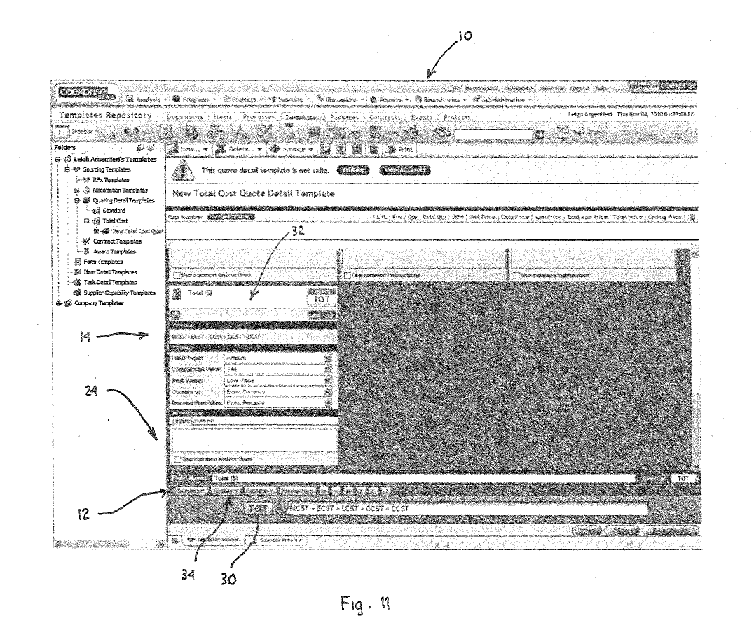

As seen in FIG. 10, each section 16 will normally include multiple variables 18 for use in determining the total cost unit price. In the examples shown, the “Quotation Information” section now includes “Material Specification,” “Material Cost” (MCST), “Equipment Cost” (ECST), “Direct Labor Cost” (LCST), “Profit and Overhead Expenses” (OCST), and “Packaging and Delivery” (DCST). As discussed, certain of these variables 18 have been assigned a symbol for later use, including MCST (material cost), ECST (equipment cost), LCST (direct labor cost), OCST (profit and overhead expenses), and DCST (packaging and delivery cost). In particular, and as illustrated in FIG. 11, the standard unit price is often defined as: TOT=MCST+ECST+LCST+OCST+DCST. However, and again, one of the unique aspects of the present invention is using this standard unit price as part of a greater analysis and determination of total cost unit price, which takes into consideration additional factors (including both price and non-price factors) and variables 18 than those set forth above.

In another preferred and non-limiting embodiment, and as illustrated in FIGS. 10 and 11, the user may create a calculated variable 32, which, in this example, is the standard unit price (TOT). Accordingly, the user interface 10 provides the appropriate selectable options 12 for naming the variable, assigning a symbol, defining an equation, defining a function, or the like. Further, the parameters 26 for the variable section 24 for the calculated variable 32 permits entry for the above-discussed field type, comparison view, best value, currency, decimal precision, and unit of measurement. In addition, this calculated variable 32 facilitates the creation of a formula or equation for arriving at some calculated number or value.

In order to create this equation or formula, the user interacts with certain equation definition options 34, which allow for the selection of: previously-created variables 18 (through the use of their associated symbols 30); global variables 18; system variables 18, which are high-level system-wide variables 18 associated with information for defining the total cost unit price; a listing of functions, which are used to define how the equation should operate or obtain information and data; and mathematical operators. This provides the user with a complete selection of options for defining an equation or formula assigned to a specific calculated variable 32 in the manner best suited to the buyer B. The above discussed standard unit price variable (TOT) is one example of a calculated variable 32.

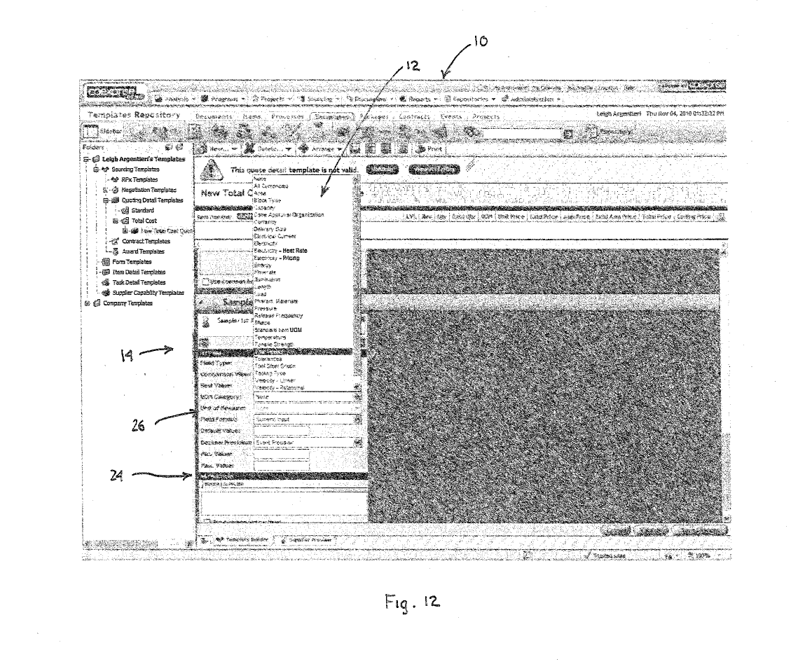

In FIG. 12, the user creates a new standard section 22, named “Samples,” with a variable 18 named “Samples/1^{st} Article Lead Time” (SLED). One of the parameters 26 of this variable 18 that requires modification is the unit of measurement category. In particular, this specific parameter 26 is assigned “Time Period” for defining the variable 18. Furthermore, this variable 18 is further defined by a specific unit of measurement associated with the unit of measurement category, e.g., bi-monthly, bi-weekly, day, hour, minute, month, week, year, etc. Under this standard section 22, additional variables 18 can be added, such as production part approval process lead time, or the like. However, any type of variable 18 can be selected, and again, the system includes built-in business logic for determining the parameters 28 associated with the selected variable 18.

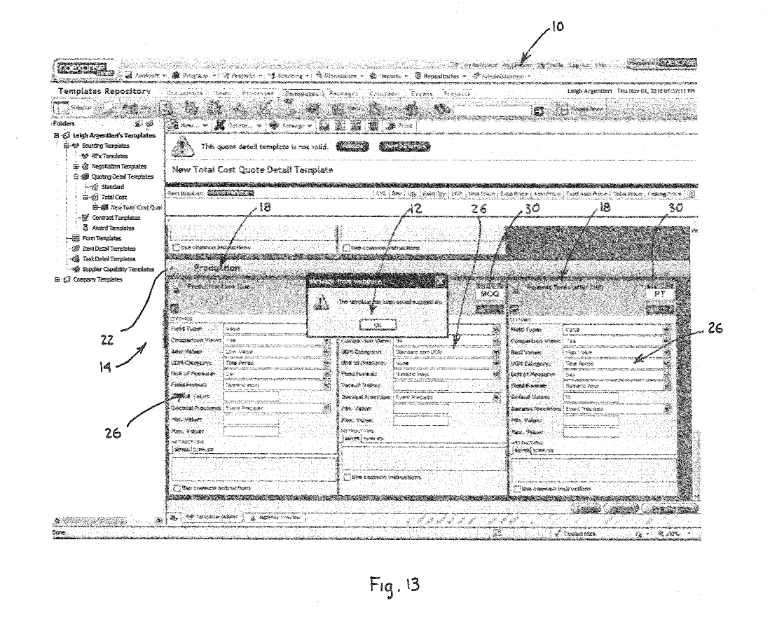

As illustrated in FIG. 13, additional standard sections 22 can be included, such as the “Production” section, which includes the variables 18 of “Production Lead Time,” “Minimum Order,” and “Payment Terms.” The “Production Lead Time” is assigned the variable RLED, and the unit of measurement category is time period, with a unit of measurement of a day. The “Minimum Order” variable is assigned the symbol MOQ, and the unit of measurement category is “Standard Item UOM.” In addition, this variable 18 is modified to prevent a comparison view to the suppliers S and/or if desired, the buyer B. In addition, the “Payment Terms” variable (PT) is provided with a unit of measurement category of “high value” and a unit of measurement of day. The default value is 70.

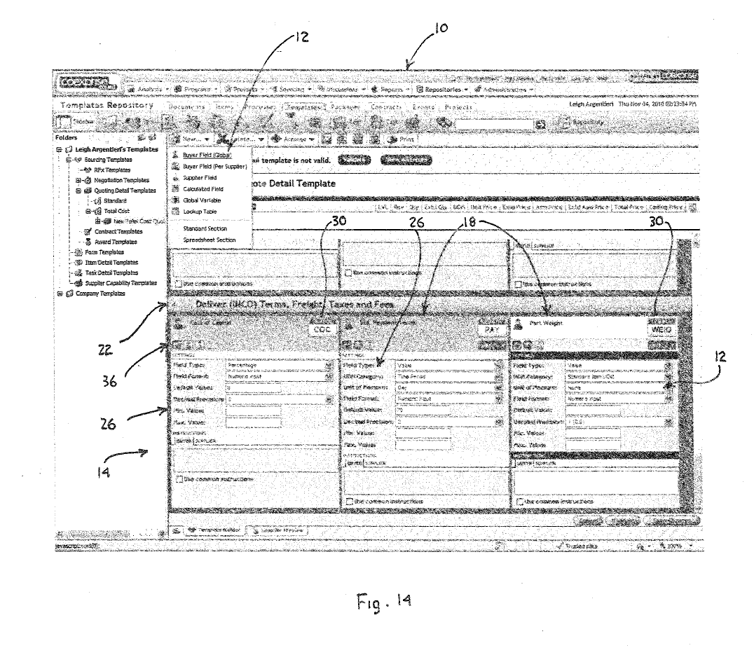

In this embodiment, and as illustrated in FIG. 14, a further standard section 22 is included and named “Delivery Terms, Freight, Taxes, and Fees,” and this standard section 22 includes the variables “Cost of Capital” (COC), “Std. Payment Terms” (PAY), and “Part Weight” (WEIG). The “Cost of Capital” is a global buyer field, which cannot be viewed by the suppliers S. Again, the ability of a supplier S to view a variable 18 (or section 16) can be toggled, such as by using one or more view options 36. The “Cost of Capital” variable is in terms of a percentage, with a default value of 8, and decimal precision of 0. The “Std. Payment Terms” variable represents a time period with a unit of measurement in days, with a default value of 70. Further, the “Part Weight” variable is a standard item, with a numeric input and decimal precision of 1 (0.0).

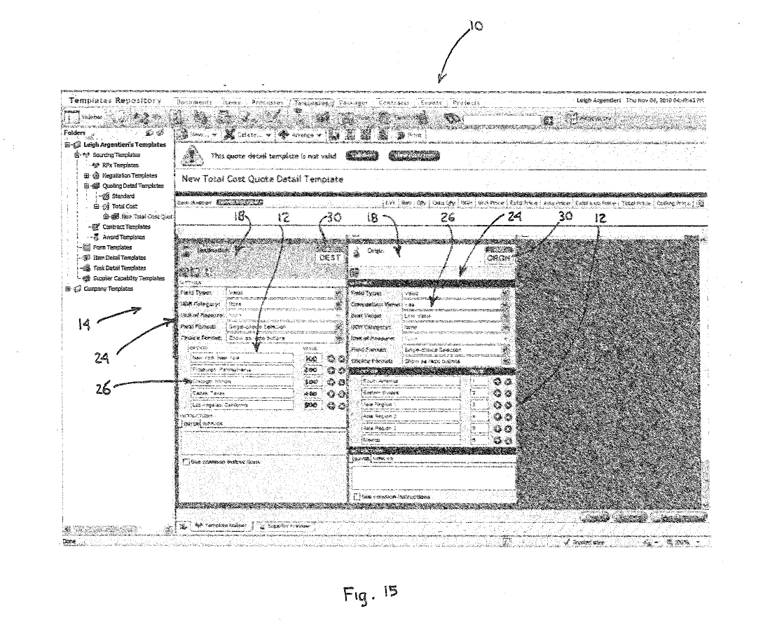

In a further preferred embodiment, and as illustrated in FIG. 15, the variables “Destination” (DEST) and “Origin” (ORGN) are created, and the field format is defined as a single-choice selection. In addition, the chosen format presents the selections as radio buttons to the supplier S. With respect to the “destination” variable, multiple cities and states are included as options, and assigned a value. Additional cities can be added or deleted from the list using the available selectable options 12. Similarly, a list is created in the “Origin” variable section 24, where the options are specified regions, which are also assigned a value.

In this embodiment, certain variables 18 may be identified as “post-bid” variables. For example, the “Payment Terms” variable may be considered a post-bid variable, which generally is a buyer field that is completed after receiving certain initial information or data from one or more of the suppliers S, but prior to determination of the total cost unit price and award of the contract. In this manner, post-bid variables 18 or fields are leveraged to allow a buyer B to analyze necessary submitted quote data for entering additional information that will be needed as part of the award process. For example, a buyer B may be determining the best packaging method for their product, and therefore may ask the supplier S to quote on expendable and returnable packaging alternatives. Once the buyer B reviews the initially-submitted information, he or she may decide which one enables the best overall total price, and therefore will select which method he or she desires for use in determining the total cost unit price. Once the appropriate method is selected, the formula for the total cost unit price (which is preferably in the summary section 20) will be complete.

This functionality is beneficial, since if the buyer B did not analyze the submitted quote information prior to making a decision, he or she may have selected the alternative packaging method that would have raised the true total cost and not provided the desired margin. Another example of a post-bid variable or field may center around duties, customs, and freight. In particular, until the buyer B understands where the supplier S will manufacture the part, they cannot know what the best method is to have that part shipped to the desired buyer B location. Therefore, such post-bid variables 18 or fields lend additional and unique functionality to the total cost management system, method, and apparatus of the present invention.

As discussed above, the total cost template 14 can be built and subsequently modified to suit the particular needs of the buyer B. Further, this total cost template 14 can be modified in only certain areas (as opposed to building an entire new total cost template 14) for use between similar buyers B or similar sourcing events. In a further embodiment, the selectable options 12 on the user interface 10 allow the user (or buyer B) to toggle the total cost template 14 to the supplier S view. Accordingly, this will allow the buyer B to see exactly what and how the sections 16 and variables 18 are presented to the supplier S for the quotation process (as discussed in detail hereinafter).

In another preferred and non-limiting embodiment, the presently-invented total cost management system, method and apparatus provides for the use of global variables 38. Such global variables 38 may be a supplier-specific variable, a buyer-specific variable, a calculated variable, a look-up table-based variable, or the like. For example, the global variable 38 may be a standard variable, such as an expediting fee that is specific to the particular buyer B and/or supplier S. This information may be set or collected “outside” of the total cost template 14 process, whether before, during, or after the creation of the total cost template 14. Accordingly, through the user interface 10, this other information can be obtained from local or remote sources for use in creation of the total cost template 14. Still further, the global variables 38 can be a look-up table-based variable 40 or a general variable 18.

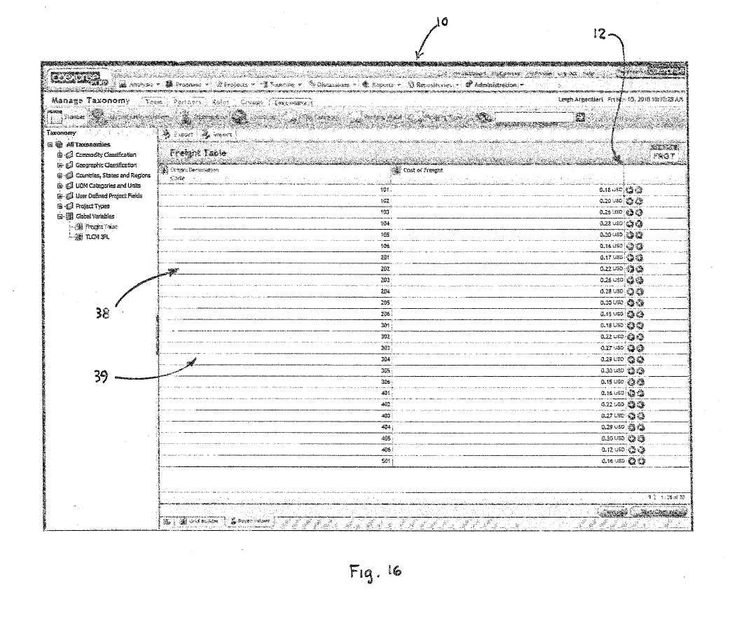

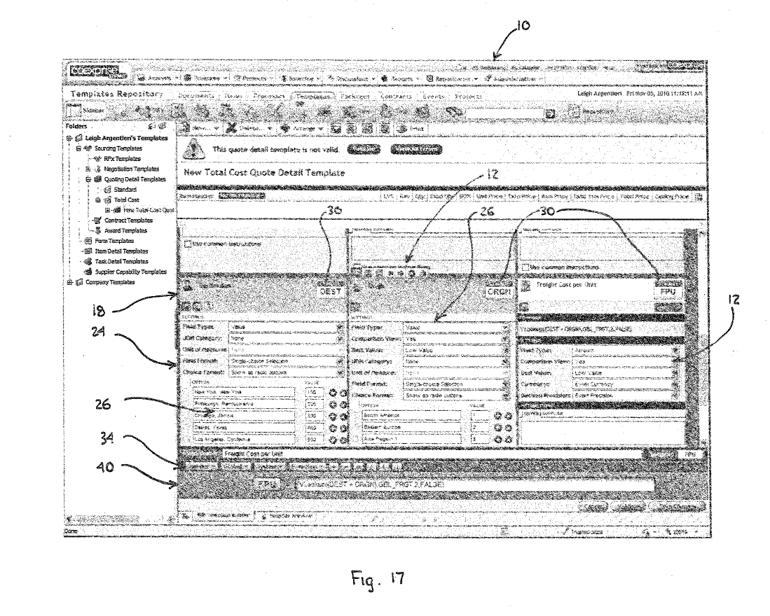

The creation of one type of global variable 38 is illustrated in FIG. 16, where a table 39 has been created for use in connection with a look-up table-based variable 40 (see FIG. 17). The creation of such a table 39 allows the user to create, modify, and otherwise configure a table (or spreadsheet), which can be parsed as part of the total cost template 14. In creating this table 39, the user defines two columns as “Origin/Destination Code” and “Cost of Freight.” Under the “Origin/Destination Code” column, certain values are provided, and under the “Cost of Freight” column, certain dollar values are provided.

The above-described table 39 can then be used to determine additional information within the total cost template 14. For example, as seen in FIG. 17, and with reference to the “Destination” variable and “Origin” variable discussed above, a new look-up table-based variable 40 is created, namely the “Freight Cost per Unit” variable, which is assigned a symbol of FPU. The information and data obtained in connection with the DEST and ORGN variables 18 is used in connection with the look-up table-based variable 40 (FPU) to determine certain required information. Further, the “Freight Cost per Unit” may also be considered a calculated variable 32. Accordingly, a formula is assigned to the variable 18 as follows: VLookup((DEST+ORGN), GBL_FRGT, 2, FALSE). In order to create this formula, the user selects the “VLookup” feature under the “function” tab (an equation definition option 34), and chooses the “Freight Table” discussed above. Generally, this formula adds the value of the “Destination” variable and the “Origin” variable, and based upon the resulting numeric value, looks for a match in the table 39 of FIG. 16. Accordingly, this allows the buyer B to obtain additional useful and detailed cost information for use in determining the total cost unit price.

In another preferred and non-limiting embodiment, a spreadsheet section 42 can be added to the total cost template 14. This spreadsheet section 42 provides unique spreadsheet-like functionality for determining additional information and data associated with variables 18 for use in calculating the total cost unit price (or other intermediate determinations). Further, the spreadsheet section 42 provides supplier S variability in response data, e.g., one supplier S may have 5 raw materials that buyer B is requesting, while another supplier S may have 20 raw materials. Therefore, the spreadsheet section 42 provides flexibility for the supplier S to respond with as many instances as needed to provide the necessary response. In order to provide this functionality, multiple spreadsheet options 44 are presented to the user on the user interface 10.

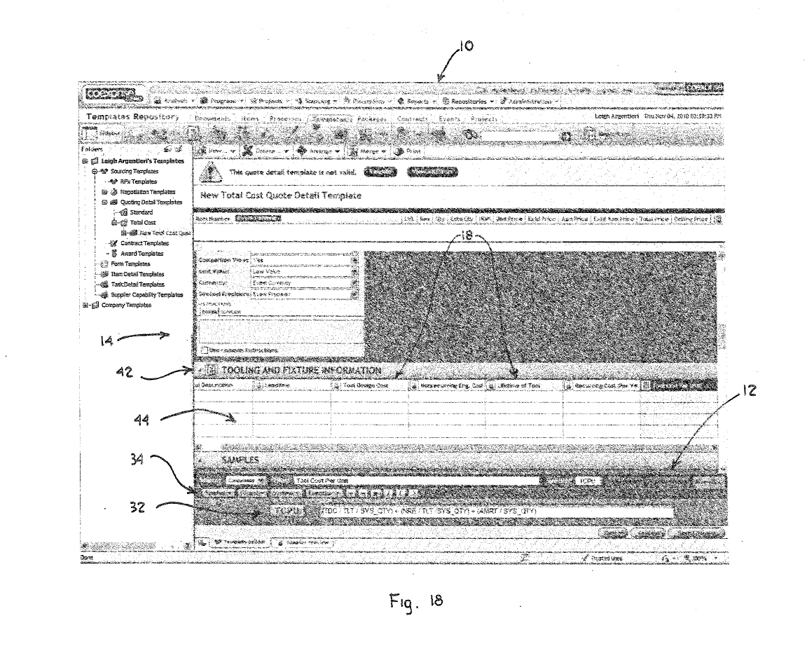

For example, these spreadsheet options 44 may include defining or naming a column or row, defining or naming one or more variables 18, defining one or more parameters 26 associated with the spreadsheet section 42, and the like. For example, as illustrated in FIG. 18, the following columns are defined: “Tool Description” (which is a text-based entry), “Lead Time” (which is a time period-based entry), “Tool Design Cost,” “Non-Recurring Eng. Cost,” “Lifetime of Tool,” “Recurring Cost (per Year),” and “Tool Cost Per Unit”. Furthermore, each of these entries can be defined and have symbols 30 assigned thereto, such as TCPU (Tool Cost Per Unit). Also, other parameters 26 can be used to configure one or more of these columns or entries, such as the source, title, symbol, column-type, decimal precision, default value, minimum value, maximum value, required entry, textual instructions, formula, and the like. Similarly, certain spreadsheet properties can also be adjusted using the spreadsheet options 42, such as providing or using double-header rows, summary rows, a fixed number of rows, required input, maximum number of rows, and the like. Further, the spreadsheet section 42 may or may not have a set number of rows and/or have a row summarizing all calculable data entered. Instead, this spreadsheet section 42 represents a fully-configurable tool for gathering, reviewing, analyzing, and calculating data and information for use throughout the total cost template 14.

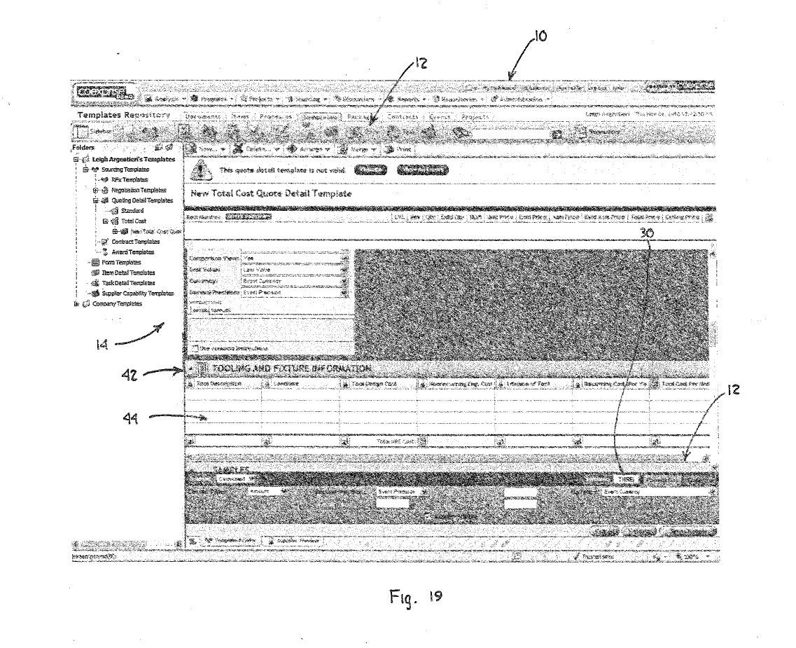

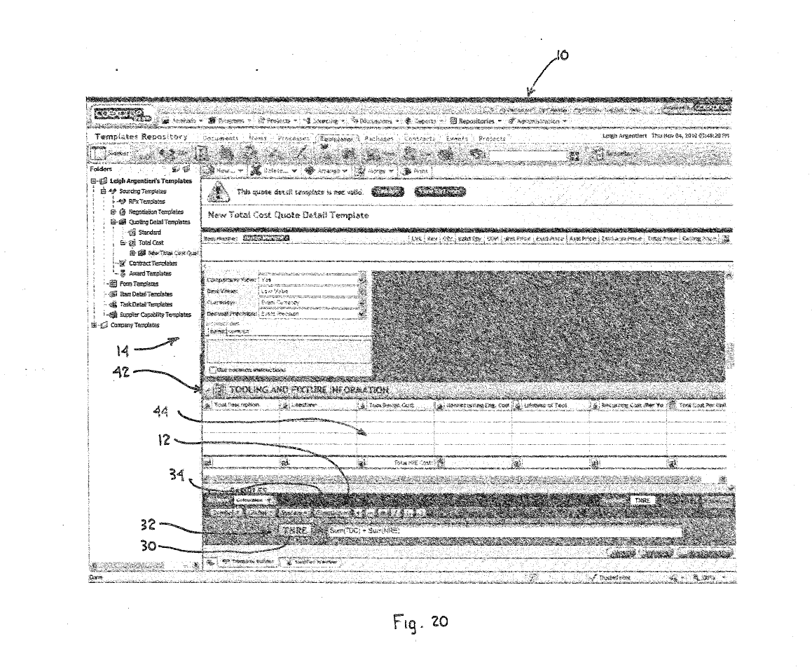

As illustrated in FIG. 18, the “Tool Cost Per Unit” variable is assigned a symbol 30 of TCPU, and this variable 18 is a calculated variable 32. Accordingly, the “Tool Cost Per Unit” variable (TCPU) is defined by the formula “(TDC/TLT/SYS_QTY)+(NRE/TLT/SYS_QTY)+(AMRT/SYS_QTY). See FIG. 19. Within the spreadsheet section 42, certain spreadsheet options 44 are provided to engage in the known functions of a spreadsheet, such as providing equations or otherwise manipulating numerical data within the columns and rows. For example, as illustrated in FIG. 20, the “Total NRE Cost” variable is assigned the symbol 30 of TRNE, and formulaically defined as “Sum(TDC)+Sum(NRE),” which is the summation of the “Total Design Cost” and “Non-Recurring Eng. Cost” columns. Similar summarizations and equations can be inserted in the spreadsheet section 42, such as the calculation of “Total Amortized Cost” and/or “Tool Cost Per Unit.” Further, as seen in FIG. 18, the variable “Tool Cost Per Unit” (TTCU) is calculated, and represents the primary variable 18 in this example. Accordingly, such a spreadsheet section 42 provides advanced spreadsheet-style functionality for collecting, identifying, and calculating certain intermediate variables 18 for eventual use in determining the total cost unit price.

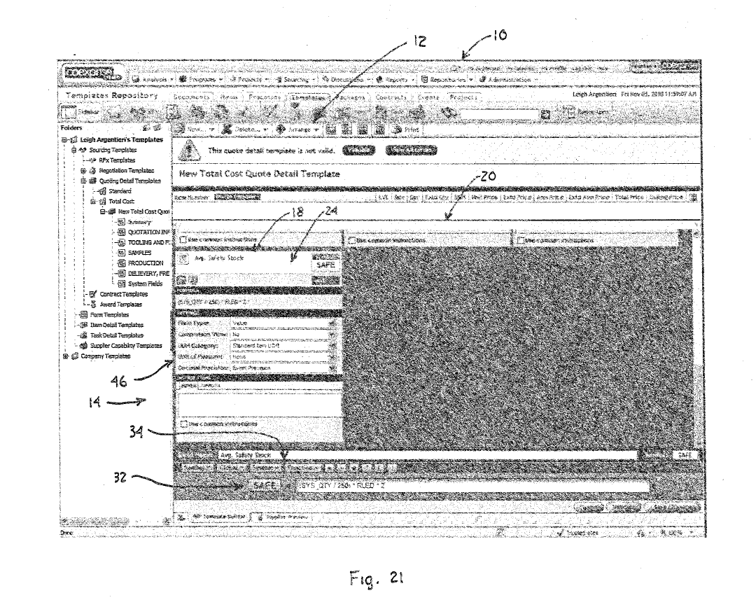

While the summary section 20 was immediately created upon creating the total cost template 14, its primary utility is derived after completion of the above-discussed standard sections 22 and spreadsheet sections 42. This summary section 20 includes certain high-level summary information and variables 18 for use in determining the total cost unit price 50. For example, as seen in FIG. 21, certain summary variables 46 are included, such as “Supplier's Quoted” (PTOT), “Number of Shipments” (NOSh), “Number of Units per Shipment” (NOUP), and “Avg. Safety Stock” (SAFE). As discussed above, the summary section 20 presents or provides certain summary variables 46 that the buyer B has deemed necessary or important for top-level viewing and consideration. Of course, any summary variable 46 can be included in the summary section 20. Further, while not always the case or required, the summary variables 46 and the summary section 20 are typically calculated variables 32, which draw the information and data from the other sections of the total cost template 14. For example, as seen in FIG. 21, the average safety stock (SAFE) variable is a calculated variable 32 as follows: (SYS_QTY/250)*RLED*2. Again, one unique aspect of the present invention is that the equations for these calculated variables 32 can be built using the symbols that define other factors and variables throughout any portion of the total cost template 14. Through the use of such symbols, the present invention leads to a much more accurate total cost template 14, which, in turn, leads to a more efficient and accurate sourcing process.

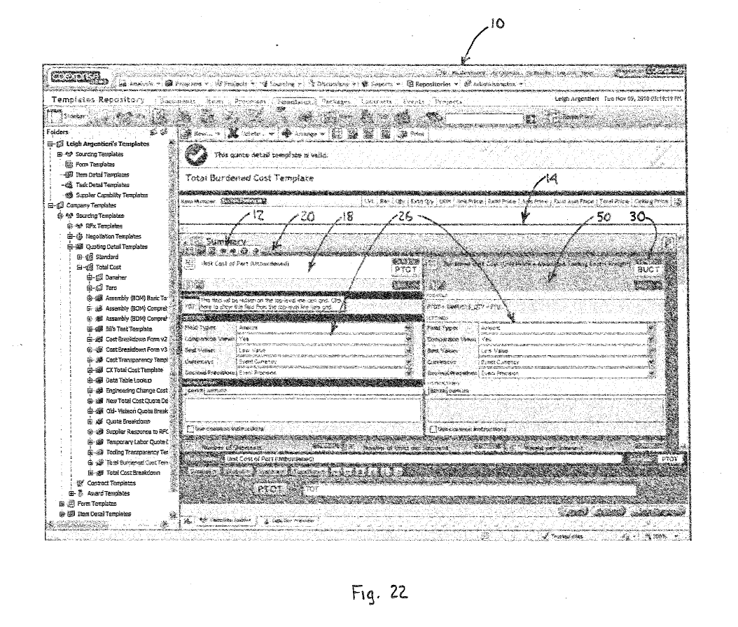

With reference to FIG. 22, certain additional variables are created in the summary section 20, including “Unit Cost of Part (Unburdened)” (PTOT) and “Burdened Unit Cost” (BUCT). The PTOT variable is assigned the value of the above-discussed TOT variable, which again represents a known manner of calculating standard unit price. The BUCT variable is a calculated variable 32, with the defined formula: PTOT+TAMR/SYS_QTY+FTU, where PTOT is the standard unit price, TAMR is the sum of certain recurring costs (e.g., amortized tooling cost AMRT), SYS_QTY is the quantity of parts/items, and FTU is the freight per unit cost. Therefore, the total cost unit price 50 has been tailored and defined to capture all of the costs that are important to the specific buyer B. While this equation or formula for total cost unit price 50 is one example for a particular buyer B, one innovation of the present invention is that each individual buyer B can define the underlying equation or formula in any appropriate manner. Accordingly, the buyer B is provided with a total cost unit price 50 that is truly representative of that particular buyer's assessment and internal determinations. Also, through such beneficial functionality, the buyer B can redefine the total cost unit price 50 at will after receiving the information and data from the suppliers S, such that the buyer B can output different scenarios for determining the total cost unit price 50. While this total cost unit price 50 (in this example, BUCT) is typically included in the summary section 20, it can be defined on the system level, as discussed hereinafter.

Generally, the summary section 20 provides the buyer B with the variables 18 (and data associated therewith) that is deemed the most important in making the sourcing decision. Therefore, this key information and data is immediately viewable by the buyer B, but can be expanded and further analyzed in the other sections 16 of the total cost template 14 (as completed by the supplier S). Accordingly, the buyer B can establish those unique factors (variables 18) that are central in the decision-making process, and the data associated with these summary variables 46 is automatically calculated and rolled-up throughout the various other sections 16 of the total cost template 14. In one embodiment, sufficient variables 18 or information must be defined so as to define the total cost unit price 50, normally presented in the summary section 20.

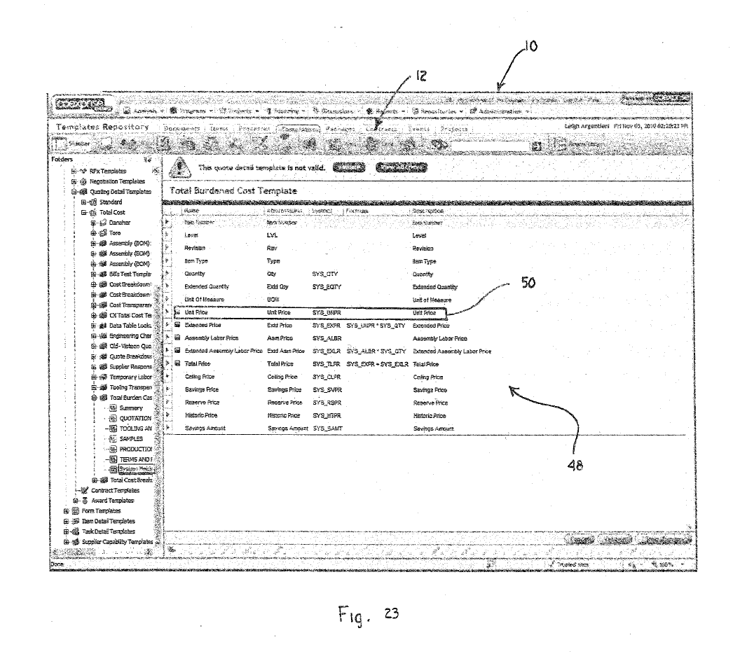

As a check on the validity of the total cost template 14, the user defines the various system variables 48, as seen in FIG. 23. In one preferred and non-limiting embodiment, the total cost template 14 cannot be validated until at least the total cost unit price 50 is defined. As seen in FIG. 23, this total cost unit price 50 (SYS_UNPR) has not yet been defined. This leads to the message that “This detailed template is not valid.”

While an undefined total cost unit price 50 may be one fatal error, other errors may lead to the total cost template 14 as being “invalid.” Accordingly, the user can attempt to validate the total cost template 14, but will receive the above-discussed message if the total cost template 14 is not valid. However, the user may then select the “View All Errors” selectable option 12 to view a detailed listing and explanation of why the total cost template 14 is not valid, e.g., the total cost unit price 50 has not yet been defined. As also seen in FIG. 23, these system variables 48 define high-level and basic default variables for common use across variable total cost templates 14. However, and again, the total cost unit price 50 can be specifically defined and accorded a formula or equation individually by each buyer B or in various applications/negotiations.

In the example of FIG. 23, the system variables 48 include item number, item level (e.g., part, sub-assembly, assembly, etc.), revision, item type, quantity (e.g., number of assemblies), extended quantity (e.g., the total of all quantities of all assemblies), unit of measurement, unit price (as discussed above and hereinafter), extended price (e.g., unit price times quantity), assembly labor price, extended assembly labor price (e.g., the extended labor price times the quantity), total price (e.g., extended price+extended assembly labor price), ceiling price, savings price, reserve price, historic price, and savings amount. In addition, each of these system variables 48 may be displayed at various positions throughout the total cost template 14 user interface 10, such that the user can effectively utilize these high-level variables in building the total cost template 14.

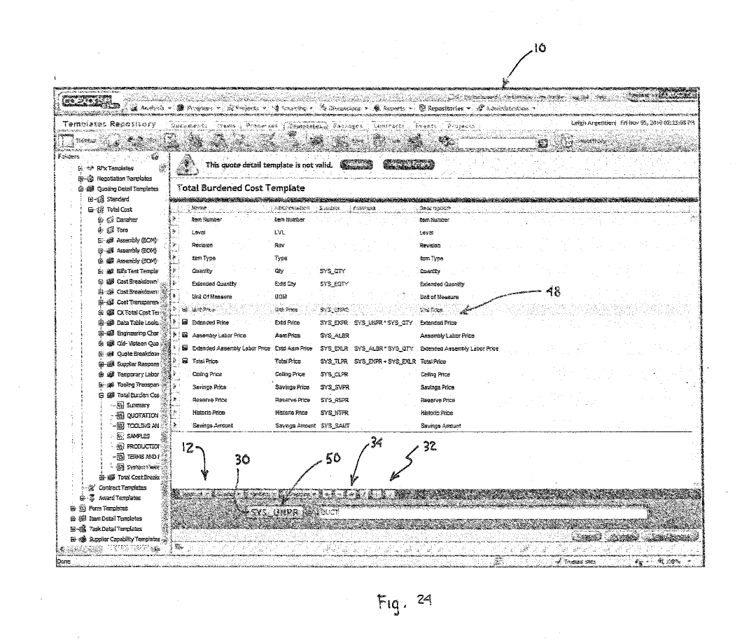

As seen in FIG. 24, and in another example of the present invention, the user completes the validation process by defining the total cost unit price 50. In particular, this total cost unit price 50 (SYS_UNPR) is defined as the burdened unit cost (BUCT), which may or may not be separately defined in the summary section 20 of the total cost template 14. See FIG. 22. In particular, the buyer B may desire to have this final equation or formula to determine the total cost unit price 50 present in the summary section 20, or alternatively, define this variable directly in a section listing all the system variables 48. Once complete, the total cost template 14 can be transferred from the administrative user or buyer B to another portion or area of the system. Further, certain access and modification rights can be assigned to various users in order to permit viewing, modification, and/or use of the total cost template 14 in a negotiation or sourcing event. It is further noted that in another preferred and non-limiting embodiment, system variables 48 facilitate the ability to extract information from identified legacy systems, e.g., enterprise resource planning (ERP) systems, accounting systems, etc., and map this information to one or more of the variables 18 of the total cost template 14. This information can be external or internal to the buyer B or total cost template 14, and further may be static, dynamic, and/or calculated. Accordingly, the extracted information is mapped to the required areas or variables 18 of the total cost template 14. This enhances the ability of the buyer B to evaluate any variances in the current event.

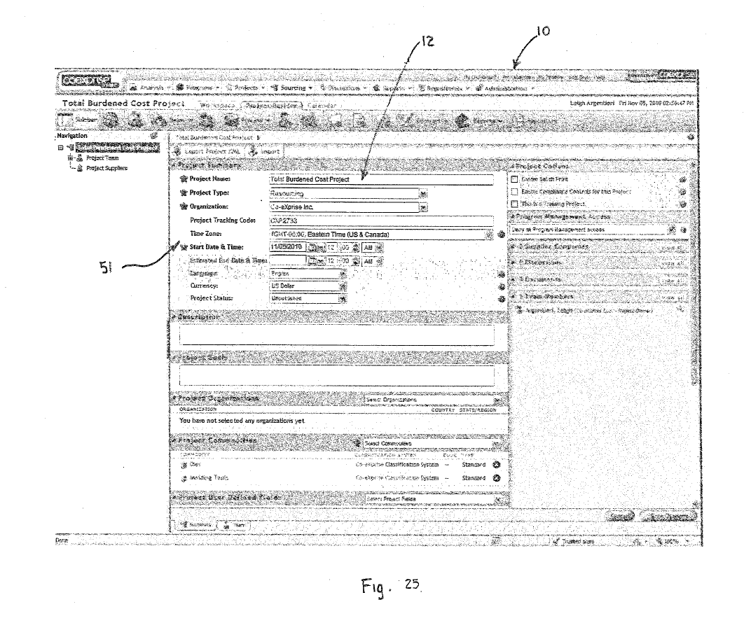

Once complete, the total cost template 14 can be used in creating and managing a total cost project or sourcing event. First, the buyer B creates the event or project and completes all necessary fields to begin the process. For example, and as illustrated in FIG. 25, the buyer B can define certain project data 51, such as the project name, project type, organization, project tracking code, time zone, start date and time, estimated end date and time, language, currency, description, project goals, project organizations, project commodities, project user-defined fields, project icon, program management access, and the like. Within this “project,” a total cost event or sourcing event is initiated. As also seen in FIG. 25, the user interface 10 allows the buyer B to effectively manage all aspects of the project and/or event, including contacts with the various suppliers S, communication management, document management, team member management, and all other aspects of the total cost management system of the present invention.

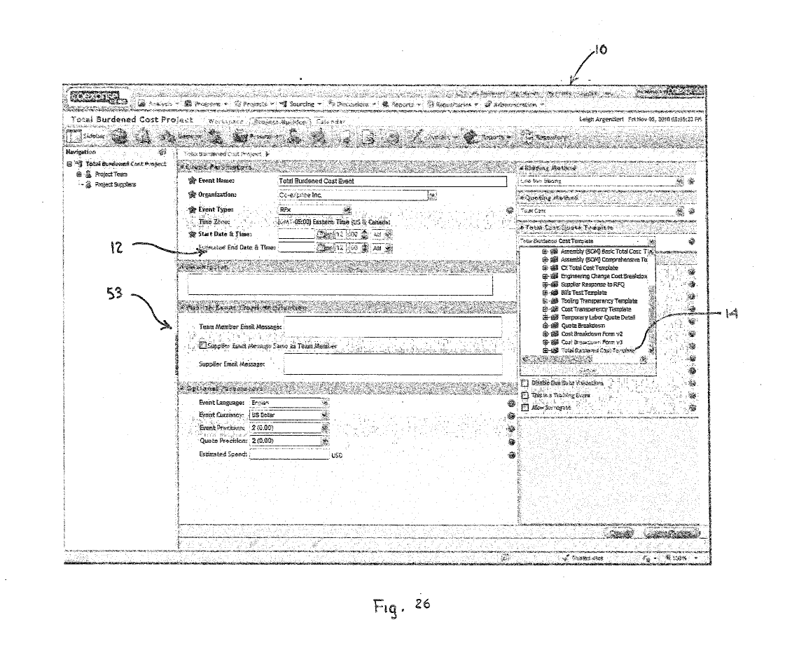

Once the project has been created, an event can be added. Accordingly, event data 53 is provided, e.g., event type (request for quotation, an assembly, a negotiation and/or collaboration), bidding or quotation method (a lot-based bidding process, where each supplier S must quote all items, or a line item bidding process, where each supplier S can pick and choose between quoting on various items), event category (a standard type event, as is known, or a total cost event, as is described in the context of the present invention) and other event information. As seen in FIG. 26, the user then selects which template or templates should be sent to the various suppliers S, and in this example, the “Total Burden Cost Template” is chosen from a total cost template drop-down menu.

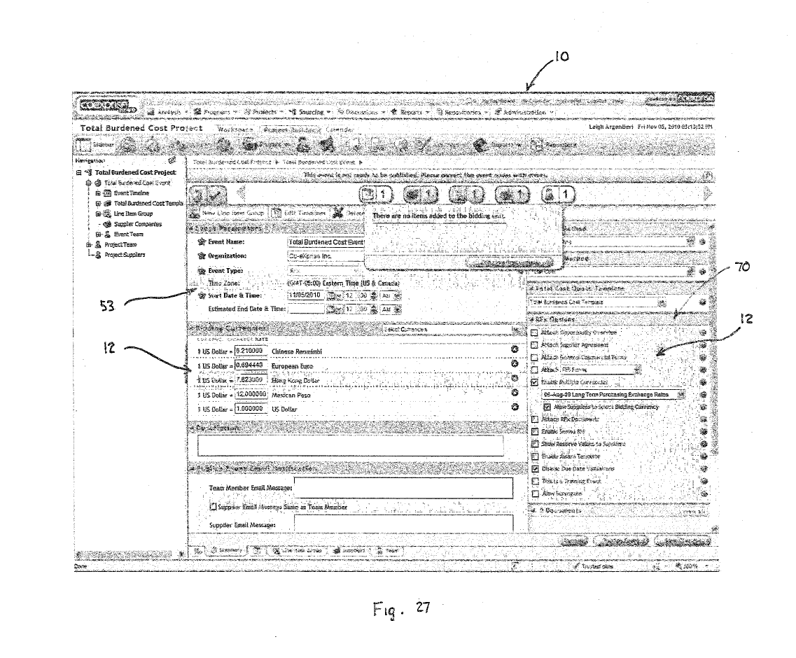

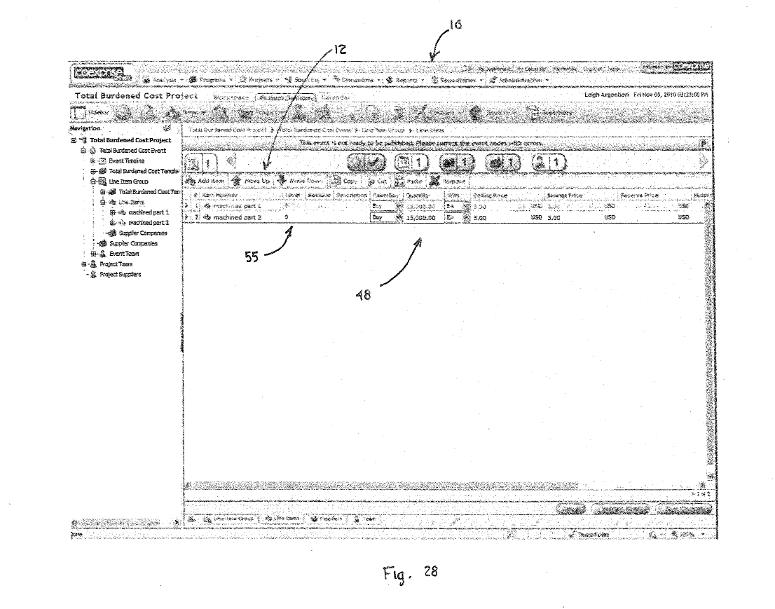

Another unique aspect of the present invention is the ability to enable a multi-currency-type sourcing event, as illustrated in FIG. 27. This allows each supplier S to prepare and respond to the fields, questions, and variables of the event in the desired currency (if enabled). The system of the present invention will ensure that all appropriate, accurate, and timely conversions are made so that the collected data can be accurately comparative between suppliers S. In addition, this comparison will occur in the event currency chosen by the buyer B. Further, the buyer B may pick and choose between the currencies that will be allowed within the event. Further, the starting date and time of the event is established as part of the initial event data 53. As also seen in FIG. 28, certain event parameters, bidding currencies and other information has been set for a specific event.

Similar to the multi-currency function, the present invention further provides the ability to automatically translate and/or reformat any portion or output to a specified language. Therefore, all or a portion of the user interface 10, the selectable options 12, the total cost template 14, or any other portion of the system (or is visual or aural output) can be translate between languages. Accordingly, the present invention provides a globally-useful total cost management system that ensures accuracy and enables unhindered communication.

The present invention provides certain icons or other graphical elements that ensure that the mandatory data elements are established prior to publication of the event, and that incomplete optional elements are highlighted to ensure that the buyer B has all necessary data elements. For example, as seen in FIG. 27, while the start data and time has been set, as well as the buyer B information, no line items have yet been added. This can be indicated to the user in a variety of ways, such as through colored icons that indicate more information must be included prior to publication. For example, a green icon indicates that the event can be published, a yellow icon indicates that the event may be published, but in an incomplete form, and red icon indicates that the event cannot be published, since mandatory items are missing or deficient. Still further, the present invention ensures that all of the steps of context-based business rules are completed in a total cost template 14. For example, and with respect to the total cost template 14, the present invention provides intelligence (e.g., mandatory data elements, rules, and the like) surrounding existing business rules, which may be unique to each total cost template 14. These rules may be dynamically generated, and graphical indicators may be provided regarding the levels, presence, absence, or requirements regarding certain data elements or rules.

Still further, and with respect to this event-based navigation and management functionality, the behavior of each type of event is mapped or tied to business rules that facilitate the validation of the event. An event may be added to a project, and certain options or activities (including validation parameters, business rules, specified attachable documents, and the like) are dynamically generated by the system. In this manner, each unique event inherits the business rules that should be associated therewith, and the dynamic generation of validation parameters occurs based upon these business rules.

As seen in FIG. 27, certain business rules facilitate the generation of options in the context of a total cost quotation event. In the exemplary embodiment of FIG. 27, an options section 70 is generated, and offers the user with the ability to: attach an opportunity overview, attach a supplier agreement, attach the general commercial terms, attach other related documents or forms, enable the user of multiple currencies, enable the suppliers S to choose the bidding currency, attach request documents, enable a sealed bid, provide reserve values to the suppliers S, enable an award template, disable due date validations, indicate the event as a training event, and allow a surrogate. For example, the opportunity overview is a description of certain parameters, such as non-price or non-cost factors, for use by the supplier S to understand the sourcing opportunity, e.g., e.g., lead time, manufacturing capabilities, quality certifications, adherence to specifications, supplier status, shipping information, inventory information, delivery information, shifts-per-day, raw materials, etc. The supplier agreement defines the buyer's B conditions and expectations for doing business with the buyer B, such as in the form of the buyer-defined market rules. The general commercial terms facilitate the definition of the commercial terms and conditions applicable to one or more of the suppliers S. The document attachment option permits the buyer B to provide a form to one or more of the suppliers S in order to elicit information and data outside of the total cost template 14, e.g., information that is common to more than one item, assembly, sub-assembly, etc., additional requirements for the overall project, etc. Further, the ability to attach a request document leads to the ability of the buyer B to receive some positive indication from the supplier S that they agree to certain terms and conditions. Of course the options in the options section 70 in FIG. 27 represents only one preferred and non-limiting embodiment for use in connection with a total cost event. Other dynamically-generated business rule-based options can be included for each different type of event.

In FIG. 28, the user adds one or more items to the event for quotation, including certain item data 55. In addition, one or more of one of the above-discussed system variables 48 are also set at this point. In this example, Item No. 1 is “machined part 1,” which is a bought item with a quantity of 15,000 (where the unit of measurement is “each”), a ceiling price of $3 US dollars and a savings price of $3 US dollars. Item No. 2 is “machined part 2,” which is a bought item with a quantity of 15,000 (a unit of measurement of “each”), a ceiling price of $5 US dollars and a savings price of $5 US dollars. Any item data 55 can be provided or configured in the section of the user interface 10.

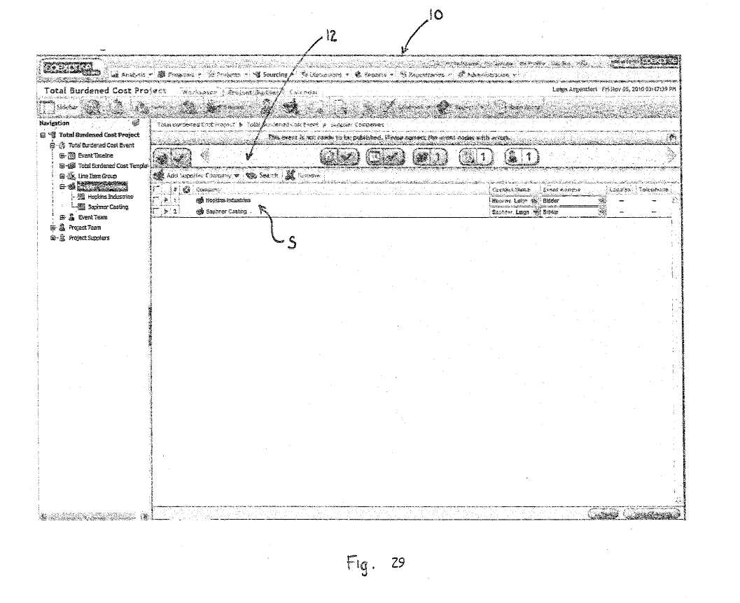

Next, and as illustrated in FIG. 29, the user adds multiple suppliers S to the event. These suppliers S can be selected from various portions of the system, such as through drop-down menus or other listings of applicable suppliers S. In addition, specific suppliers S can be searched, and/or removed from the various listings. In this example, two suppliers S have been chosen, and the appropriate supplier S information configured or included. For example, for each supplier S, the buyer B may also choose the contact name, event access, location, telephone, etc. As discussed above, while there are certain mandatory fields or data elements required to build the project and event, there may also be certain buyer-entered variables or fields in the total cost template 14 that must also be set prior to publishing the event.

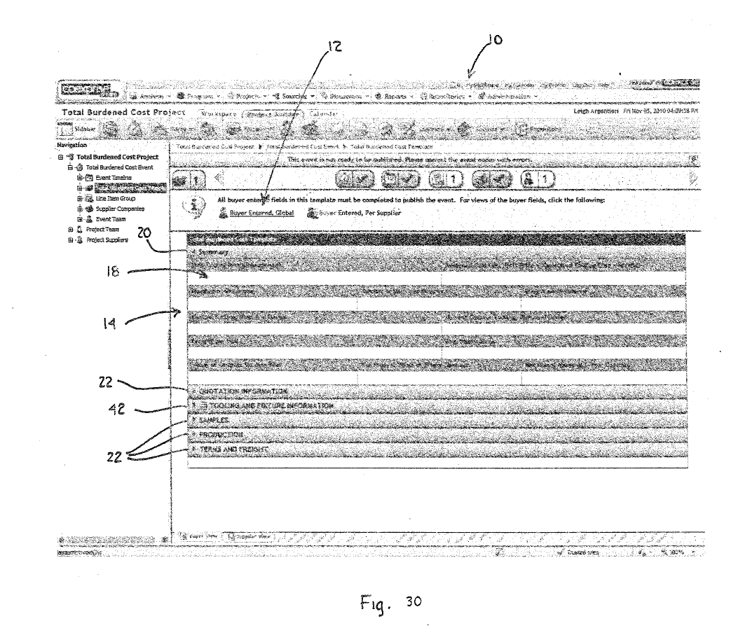

As seen in FIG. 30, the buyer B can view the total cost template 14, which, in this case, is a “Total Burden Cost Template.” This total cost template 14 includes multiple sections, including “Summary,” “Quotation Information,” “Tooling and Fixture Information,” “Samples,” “Production,” and “Terms and Freight.” Accordingly, this total cost template 14 includes the summary section 20, multiple standard sections 22, and a spreadsheet section 42. Further, under the summary section 20, the following summary variables 46 are included: “Unit Cost of Part (Unburdened),” “Burdened Unit Cost” (i.e., the total cost unit price 50), “Number of Shipments,” “Number of Units per Shipment,” “Weight per Shipment,” “Cost of Tooling, Dies, and Design,” “Upfront Cost for Tooling, Dies, and Design,” “Freight per Unit,” “Avg. Safety Stock,” “Value of Contract for First Year,” “Net Present Value of Three Year Contract,” and “Net Preset Value of Five Year Contract.” As also illustrated in FIG. 30, the buyer B can toggle between the buyer view and the supplier view to see what variables are presented or displayed to the supplier.

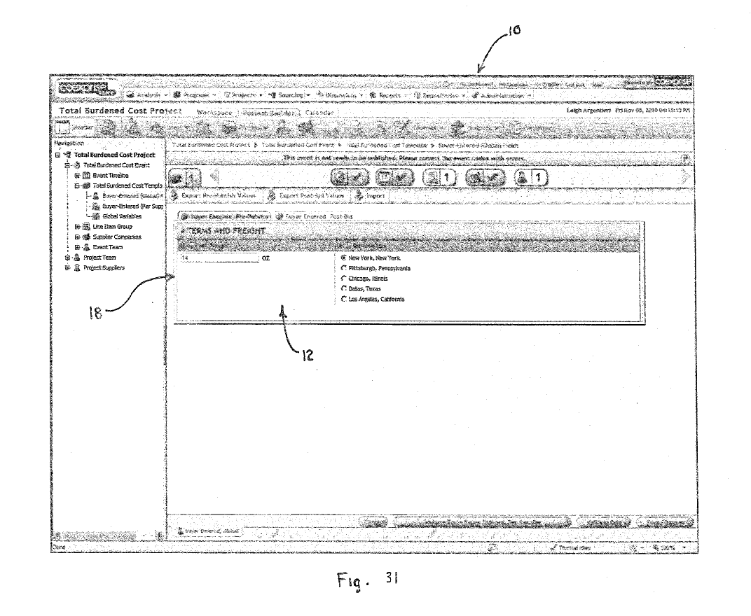

FIG. 31 illustrates certain buyer-entered, pre-publication variables that must be entered by the buyer prior to publication. In this example, under the “Terms and Freight” section, the part weight and destination must be set. As discussed above, this type of variable may be a post bid variable, where initial information is sought from each supplier S and further developed in determining the total cost unit price 50. These variables may also be buyer-specific, supplier-global, or supplier-specific. For example, each supplier S may be shipping from a specific origin or using a certain packaging method, which may be taken in to account when determining the total cost unit price 50.

Additional information that can be included in the event is identification of certain team members, both internal to the buyer B, as well as external, e.g., contacts for each supplier S. Each team member can be assigned a role, name, contact information, event access, etc. Finally, once all the information is complete, the event can be successfully published. Again, and similar to the above-discussed validation process for creating the total cost template 14, positive indications will be provided to the buyer B if certain mandatory information and data is not included when the buyer attempts to “publish” the event. This information can be relayed to the buyer B through error listings, graphical icons, and the like.

After publication, each supplier S can be notified about the request for a quotation or sourcing event of the buyer B. Each supplier S can accept the invitation, and choose which items they will bid on (in a line item-type event). For example, a particular supplier S may choose to quote on one or more of the line items, e.g., “machined part 1” and “machined part 2.” At this point, they will be presented with the supplier view of the total cost template 14. See FIG. 31.

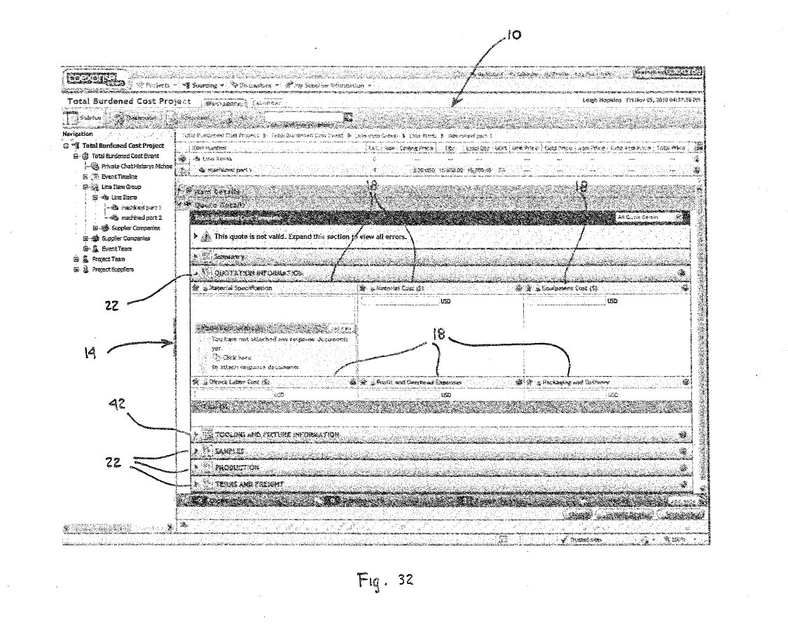

The total cost template 14 of FIG. 32 is the implementation of the total cost template 14 built by the buyer B. The supplier S accesses another portion of the user interface 10 of the system, and responds with the information for the specified variables 18. This information can be provided through direct input, such as through the use of input boxes, drop-down menus, lists, radio buttons, and the like. Further, the supplier S can attach documents, where necessary, or otherwise include the appropriate information in response to the request to the buyer B. In the example of FIG. 32, the supplier S is notified that the quote is not valid. As discussed above, this information can be specifically detailed to the supplier S for appropriate completion in response to the request. In this particular example, the supplier S has not yet attached the appropriate responsive documents under the “Material Specification” variable, and the user interface 10 displays this information to the supplier S. Further, the supplier S must complete all of the information indicated as mandatory by a red star.

In this example, the system of the present invention facilitates communication by the supplier S to certain accessible portions of the system or known navigation methods on the supplier S local system or computer. Again, and in this example, the supplier S may search his or her own computer for the appropriate document, e.g., a Material Safety Data Sheet, and upload it to the total cost template 14, specifically in the Material Specification variable section 24.

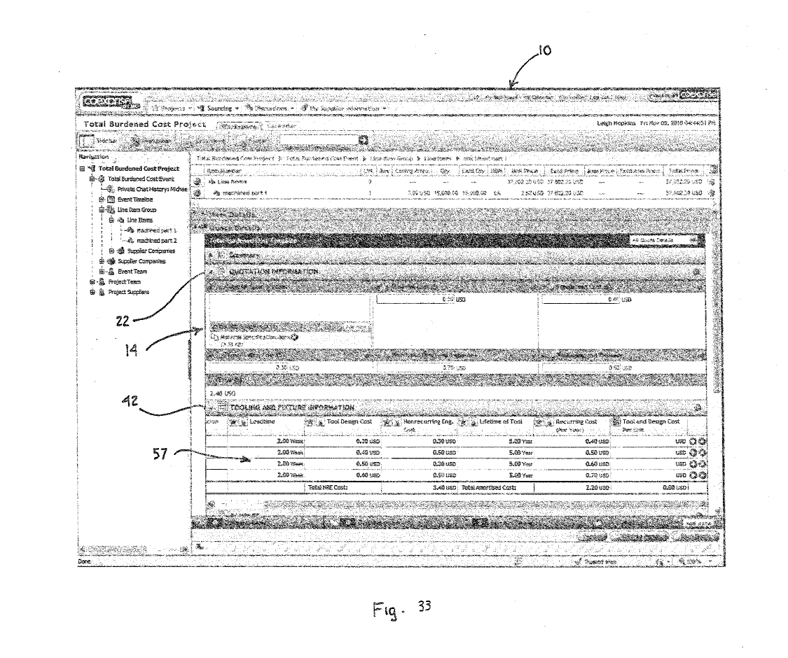

As seen in FIG. 33, the supplier S completes all necessary information in response to the total cost template 14, thereby providing all of the necessary supplier data 57 for review by the buyer B. While certain flexibility is provided to the supplier S, such as by adding additional rows to a spreadsheet section or otherwise expanding the level or detail of responsive data, the ultimate control of the type and amount of responsive data is with the buyer B. In other words, the supplier S has the ability to configure, add, delete, and otherwise manipulate response data (e.g., supplier-provided data) in the total cost template 14 on an individual basis, but within the constraints of the master total cost template 14 built by the buyer B.

Therefore, the present invention provides the unique ability to control the type, level, and amount of data provided by each supplier S in response to the request of the buyer B. This ensures consistency of responses for use in the comparison process and analysis by the buyer B. Without such useful constraints and control, each supplier S would have the ability to choose the form, content, and format of data provided to the buyer B, which may lead to the inability to appropriately assess and analyze the information of the supplier S. Accordingly, by providing the buyer B with control over not only what information must be submitted, but how it is submitted, the eventual analytical process of the quotes of the suppliers S is more efficient and more accurate.

Once complete, each supplier S submits his or her quote with the complete supplier data 57 to the buyer B. However, as discussed above, if there are certain deficiencies in the quote of the supplier S, these deficiencies will be detailed prior to submission. Once successfully completed and transmitted, the buyer B can begin the process of analyzing each supplier's S quote and response data. For example, in one embodiment, the buyer B may use this information to further develop the analysis through the use of post-bid variables (as discussed above). Further, if additional information is required, the present invention allows for communication between the buyer B and supplier S to ensure a complete bid package.

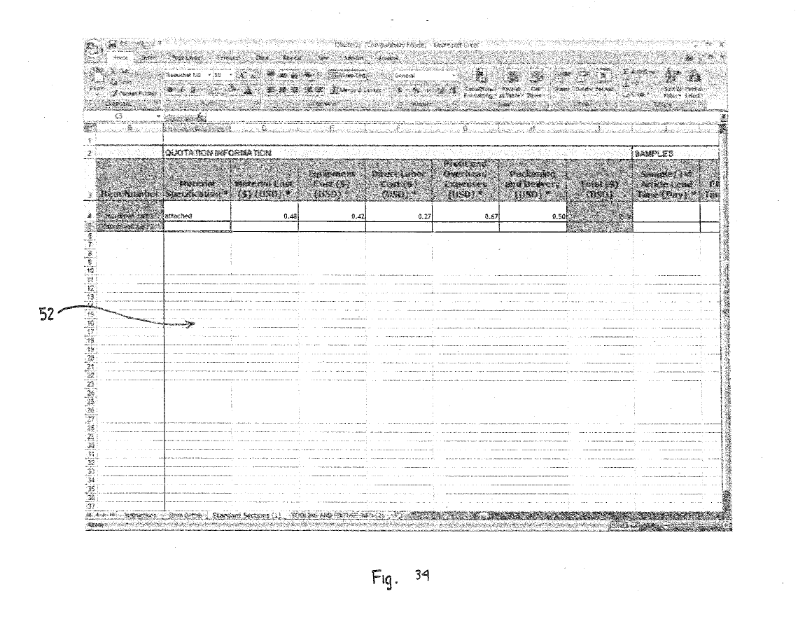

In another unique aspect of the present invention, the total cost template 14 can be exported by the supplier S for offline completion. As seen in FIG. 34, the supplier S may choose to export the total cost template 14 as a spreadsheet file 52, with macros enabled. Accordingly, the same control over input information is achieved through the use of known spreadsheet functionality, but the supplier S is allowed to complete the total cost template 14 locally at his or her computer. This allows multiple contacts or employees of the supplier S to be involved with inputting data and information into the total cost template 14 prior to submission to the buyer B. Further, by allowing exportation into the spreadsheet 52, the supplier S is able to use a known application to effectively complete the total cost template 14.

As discussed above, the supplier S may choose to quote one or more of the items in the line item-type event. Therefore, the supplier S can merely provide some indication to the buyer B that the supplier S will only be quoting on certain line items. However, in a lot base-type event, the supplier S must bid on all of the items in the lot, and failing to do so will trigger the above-discussed warnings or notifications of these “error.”

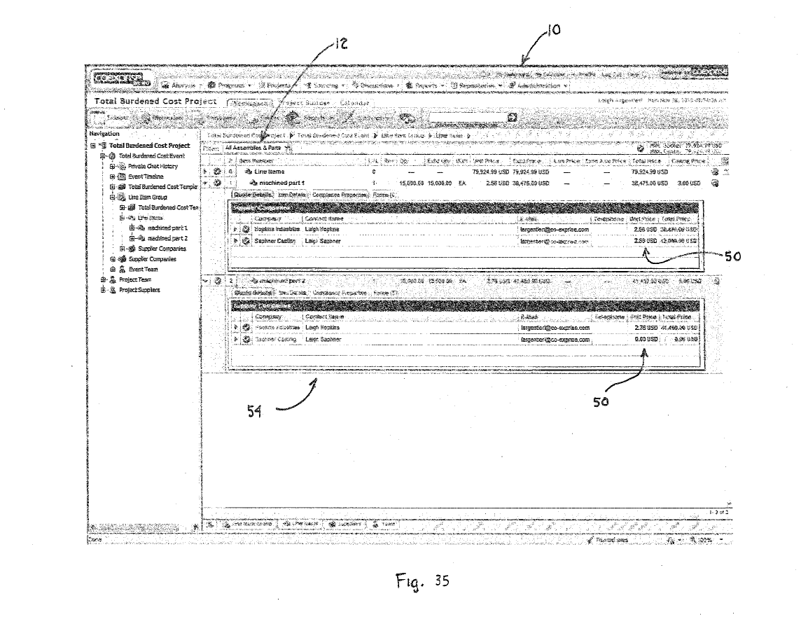

In a still further unique aspect of the present invention, the buyer B can view, review, and analyze the submitted quotes of each supplier S. In particular, the system of the present invention provides a comprehensive analytical and report (or view)-generating management tool. For example, as seen in FIG. 35, the buyer B has chosen to review both of the suppliers S for both of the items, i.e., “machine part 1” and “machine part 2.” Also, further specific information is presented to the buyer B in the form of a visual report, view, or generated and configurable section. This specific view 54 provides the buyer B with total cost unit price 50, as well as total price (which is based upon the total cost unit price 50), and this view 54 can be configured or arranged by the user in any desired manner.

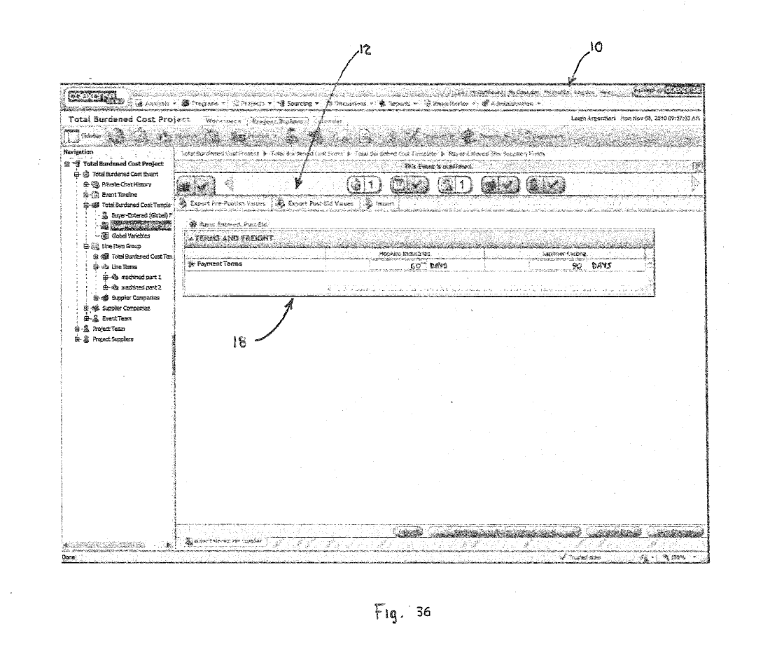

As discussed above, once the quotes or bids are received from the suppliers S, the buyer B may complete certain post-bid variables, such as the “Terms and Freight” section. In this example, and as illustrated in FIG. 36, based upon the information provided by each supplier S, the “Payment Terms” variable is completed for each supplier S. This information is then used in calculating other variables for use in determining the total cost unit price 50. This demonstrates the usefulness of obtaining and analyzing certain data points (or variables 18) after the bidding process, but prior to reviewing and making a final decision on award.

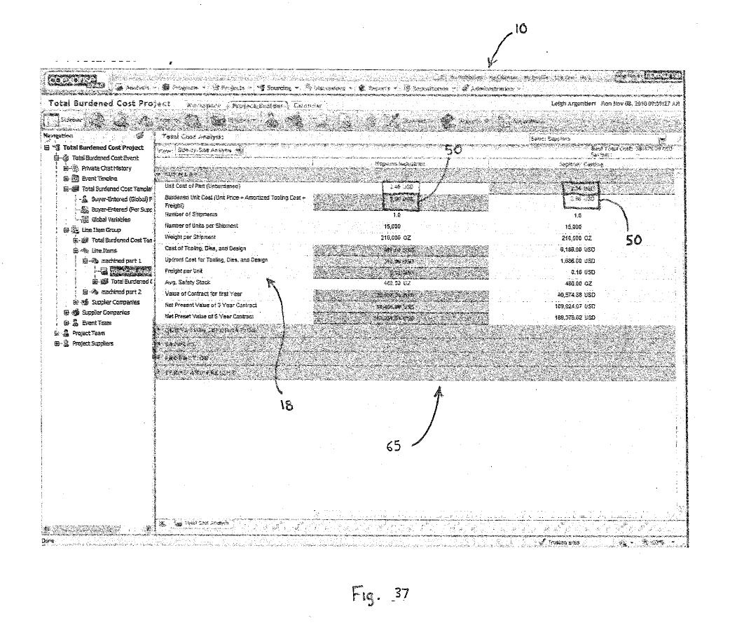

FIG. 37 illustrates a dynamic analysis node 65 on the user interface 10, where each supplier S is compared in a side-by-side manner with respect to each variable 18. In this view, the buyer B is reviewing the data or information associated with the summary variables 46. Further, this view or node 65 demonstrates some of the innovative features of the present invention. In particular, existing sourcing or event management systems calculate the known standard unit price. However, the present invention allows for the determination of the total cost unit price 50. As seen, in a typical event, the supplier S with the lowest unit price would likely have been chosen (as it represented the “best” value for this specific type of event), but through the use of the present invention, it is seen that the total cost unit price 50 of the other supplier S is “better.” As also seen, this node 65 may be color coded or otherwise provide indications as to the best price for each variable 18, as the “best” value is determined by the buyer B. Again, this demonstrates the flexibility and unique functionality of the present invention, in that the buyer B can customize any variable 18 or result in order to make a selection decision or otherwise analyze an event to determine the “best” outcome.

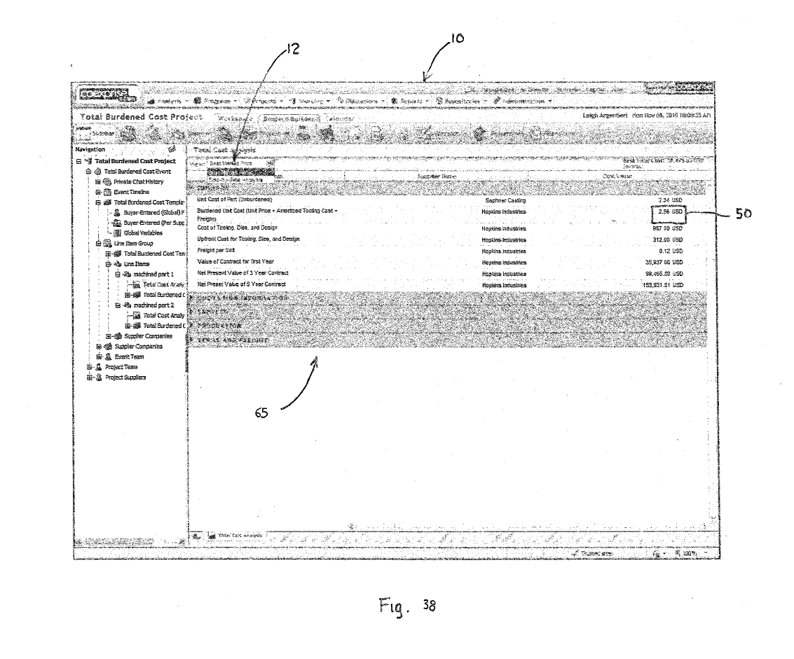

Another configurable view of the dynamic analysis node 65 is shown in FIG. 38, and this node 65 presents the best market price for each variable 18, such as each summary variable 46 in the summary section 20. This also demonstrates that the summary section 20 provides the high-level or “most important” information to the buyer B in a clear and concise manner. However, if the buyer B wishes to examine other more diverse variables 18 or perform a more granular analysis, this can be done by expanding any of the sections of the node 65 using the selectable options 12 on the user interface 10. Further and additional configurable views (within the dynamic analysis node 65) or reports 54 can be generated by the present invention. These views or reports 54 may be configurable and present any of the content, information, and/or data obtained from the suppliers S, provided by the buyer B, or derived from the supplier S or buyer B data.

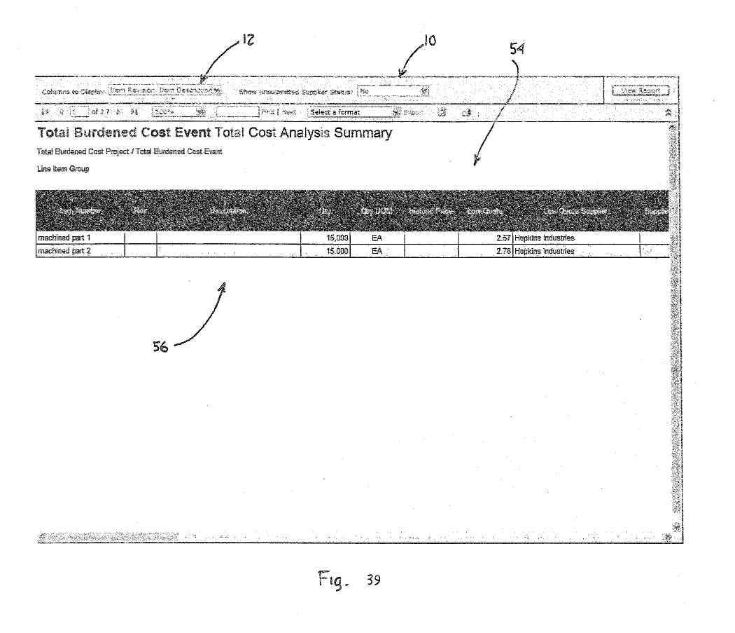

As seen in FIG. 39, a summary view or report 56 can be generated to display the data and information associated with one or more of the variables 18, as chosen by the buyer B, in an organized fashion. In this example, the information or data associated with certain variables 18 are provided for the items: “machine part 1” and “machine part 2.”

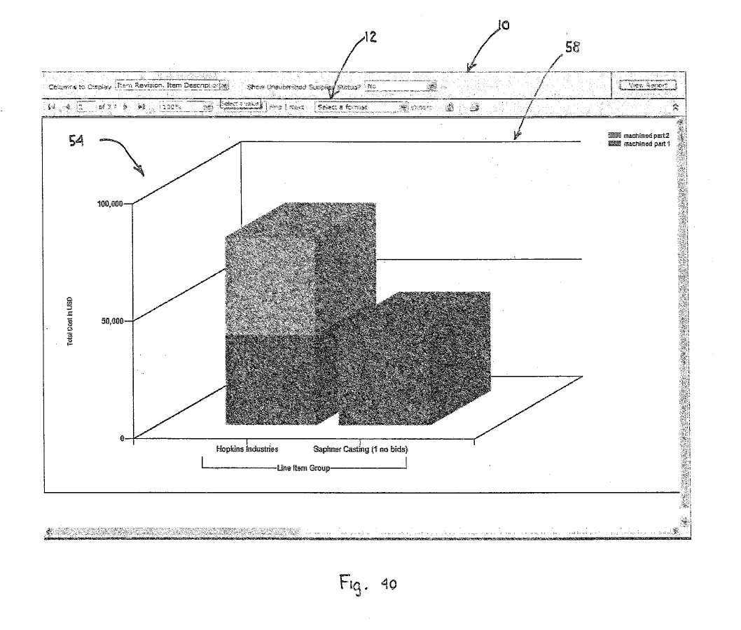

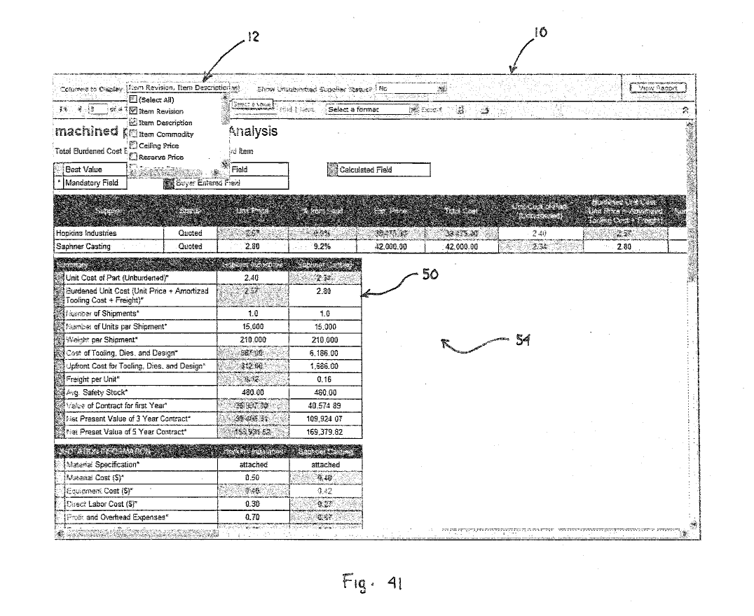

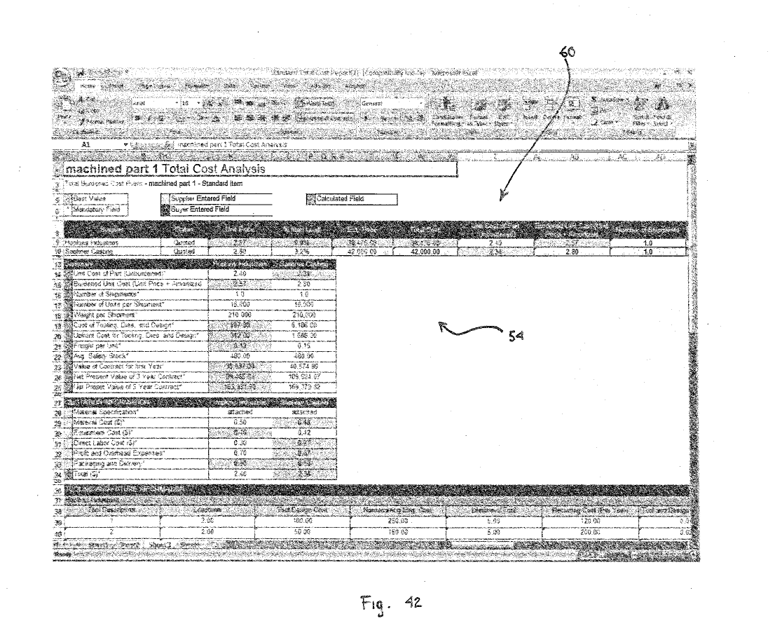

A chart view or report 58 is illustrated in FIG. 40, which is a graphical representation of specified information provided by the suppliers S (e.g., supplier data 57) in response to the presented variables 18 (as fields or questions) or data derived from the supplier S or buyer B data. As shown in FIG. 41, these reports are fully configurable, to allow the buyer B to choose the form, format, displayed variables and information, and similar data for analysis. One or more keys may also be provided to assist the buyer B in quickly assessing the nature or status of the information or variable 18 presented. This configurability is implemented through the selectable options 12, which allow the buyer B to customize the report 54 to meet his or her analytical needs. In another preferred and non-limiting embodiment, the report 54 can be exported into a separate software program, such as a spreadsheet program. For example, as seen in FIG. 42, a spreadsheet report 60 is generated for use in connection with a known spreadsheet-based software program, which allows the buyer B to do any of the typical analytical processes on the information and data of the total cost management system, method, and apparatus.

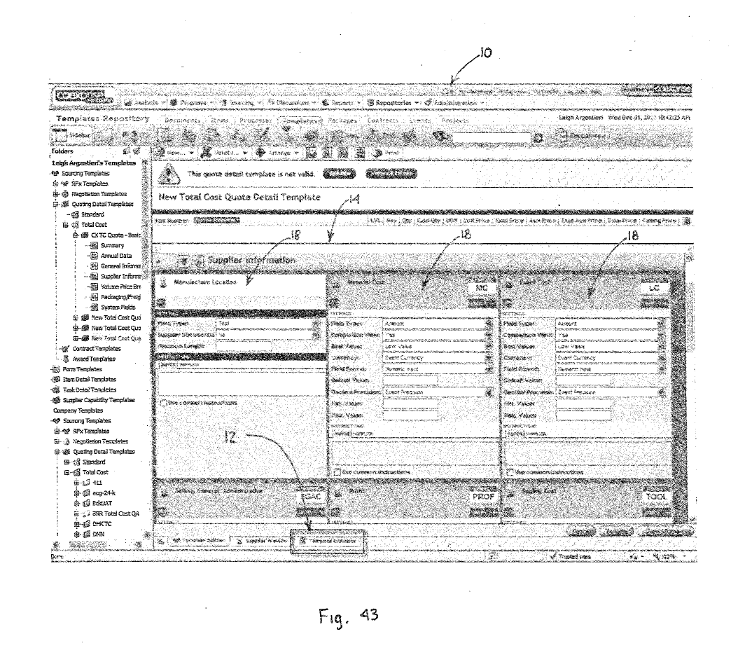

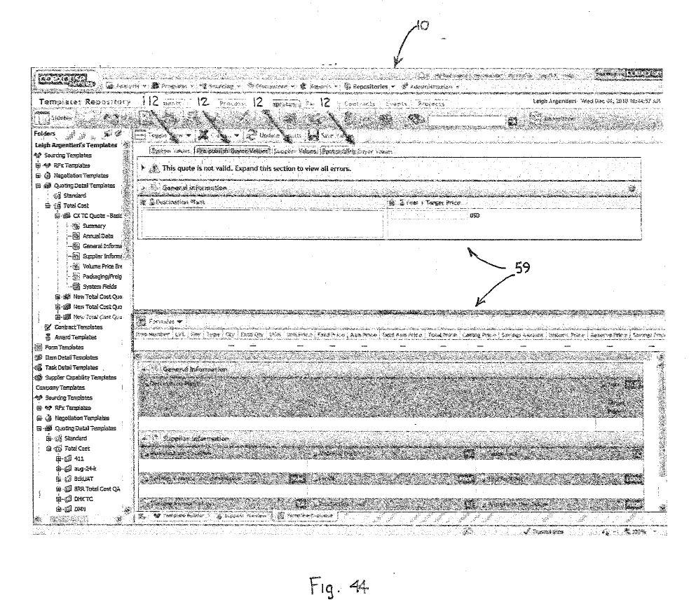

In another preferred and non-limiting embodiment, the user or buyer B may perform an intermediate evaluation or validation of the total cost template 14. As seen in FIG. 43, the user may use the “Template Evaluator” on the user interface 10 to navigate to the section shown in FIG. 44. In particular, certain selectable options 12 are provided to the user in order to validate the total cost template 14 at any point during the creation process. In the example of FIG. 44, the user is provided with validation data 59 pertaining to the various aspects and portions of the total cost template 14, including “System Values” (e.g., system variables 48), “Pre-publish Buyer Values” (i.e., those values set by the buyer B prior to publishing the event to the suppliers S), “Supplier Values” (e.g., supplier data 57), and “Post-publish Buyer Values” (e.g., post bid variables that are determined after receiving information from the supplier S). At this point, the formulae underlying or defining any of the variables can be checked and verified for consistency and accuracy. Accordingly, the user is provided a tool that permits periodic and intermediate checks to ensure that the total cost template 14 is being built correctly.

In another preferred and non-limiting embodiment, additional customization functionality is provided. In particular, while the above-discussed view options 36 can be used to set which variables 18 the buyer B and/or supplier S can see during the sourcing event and subsequent analysis, further viewing configuration and customization is available to the user while building the total cost template 14. In particular, the user is provided with certain selectable options 12 that allow for customization and configuration of viewable data, e.g., sections 16, variables 18, etc., by both the buyer B and supplier S. Still further, additional features are available to the user, which facilitate selection of the variables 18 that are viewable to the buyer B and/or the supplier S. For example, the buyer B may wish to limit the information (e.g., certain summary variables 46, other supplier data 57, etc.) that can be viewed by each supplier S, and, in some instances, certain buyer B personnel involved in the sourcing event may be prevented from viewing or permitted to view certain sections 16, variables 18, and associated data and information.

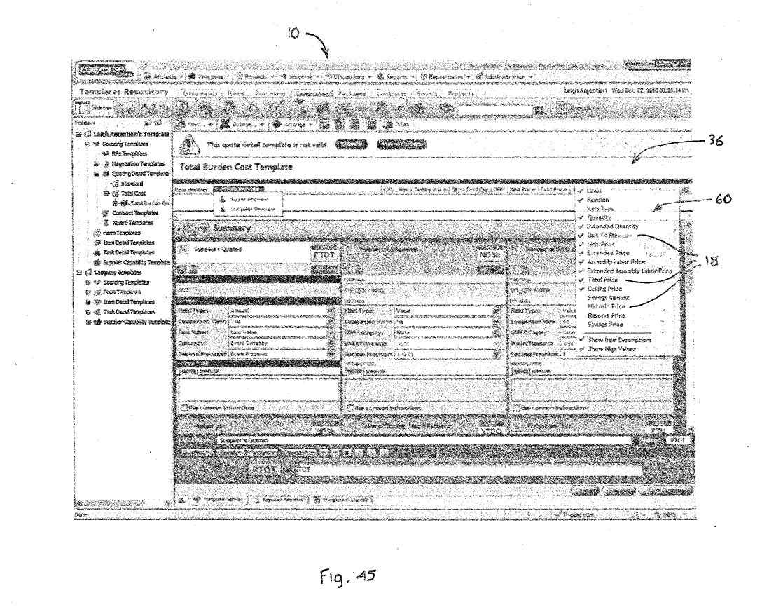

Still further, and as seen in FIG. 45, these view options 36 include the display of a selectable list 60 of certain variables 18. The variables 18 in this list 60 can be toggled “on” (i.e., viewable) or “off” (i.e., not viewable), and these selections can be made to facilitate the configuration of what the buyer B can view, what the suppliers S can view, or what each individual supplier S can view. In the preferred and non-limiting embodiment of FIG. 45, the variables 18 in the list 60 are system variables 48, with the following variables 48 set as viewable: “Level,” “Revision,” “Quantity,” “Extended Quantity,” “Unit of Measure,” “Unit Price,” “Extended Price,” “Assembly Labor Price,” “Extended Assembly Labor Price,” “Total Price,” and “Ceiling,” and the following variables 48 set as non-viewable: “Item Type,” “Savings Amount,” “Historic Price,” “Reserve Price,” and “Savings Price.” Additional view options 36 in the list 60 include “Show Item Descriptions” and “Show High Values,” which represent additional viewing functions that can be set for the buyer B and/or supplier S.

Accordingly, and in the example of FIG. 45, the “viewable” variables 18 in the list 60 are those variables 18 that the user permits the supplier S to view, and comprise those variables 18 that the user (or buyer B) believe should be available to the supplier S in responding to the buyer B request for quotation. The “non-viewable” variables 18 in the list 60 are those variables 18 that will assist the buyer B in making a sourcing decision, but information and data that the buyer B does not necessarily wish the supplier S to have. These “viewable” variables may also be continually displayed on or within the total cost template 14 on the user interface 10, for quick reference by the buyer B and/or supplier S. Therefore, the present invention provides unique viewing customization and configuration options and functionality that permit a user to specifically customize and configure the total cost template 14 with respect to the buyer B and/or supplier S. Still further, this functionality permits the user to configure the viewing capabilities of certain personnel within the buyer B organization, e.g., preventing access to certain information and data at the total cost template 14 level, while permitting access to this information and data at the report level. This viewing functionality can also be further augmented through the use of known user-access (account-based) security features, as can be implemented in any portion or at any level of the total cost management system of the present invention.

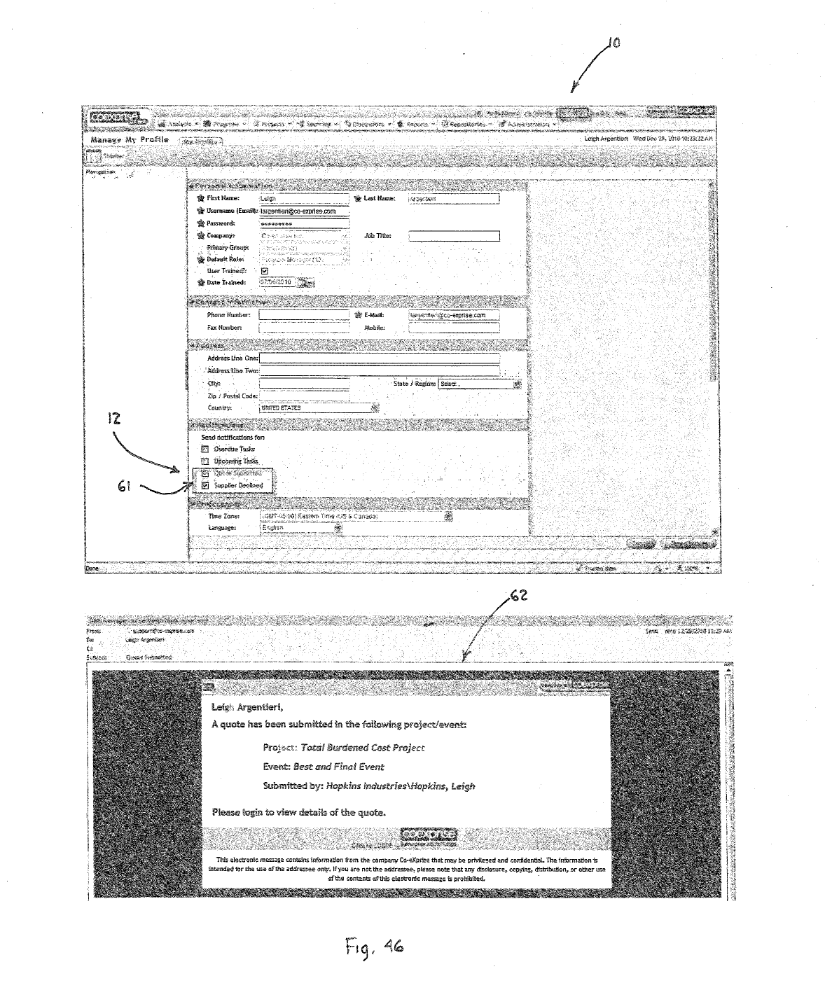

In a still further preferred and non-limiting embodiment of the present invention, and as seen in FIG. 46, the user is provided with selectable options 12 that permit configuration as to what activities the user should be notified. For example, notification options 61 can be set to generate notifications or communications regarding overdue tasks, upcoming tasks, the submission of a quote from a supplier S, and/or an indication from a supplier S that they will not be submitting a quote. Accordingly, when the user is a project manager that manages multiple events, he or she can be provided with timely notifications regarding certain tasks (e.g., tasks required or upcoming for the user's various projects) or supplier S activities (e.g., a quote has been or will not be submitted by a certain supplier S). Any desired user can receive automatically- or manually-generated notifications, and in one embodiment, such notifications, alerts, and related communications can be managed by the user in a profile section, which is unique to the user. One example notification, in the form of a notification e-mail 62, is illustrated in FIG. 46. In addition, this notification process can occur throughout any portion of the user interface 10, and is not limited to any specific event or project.

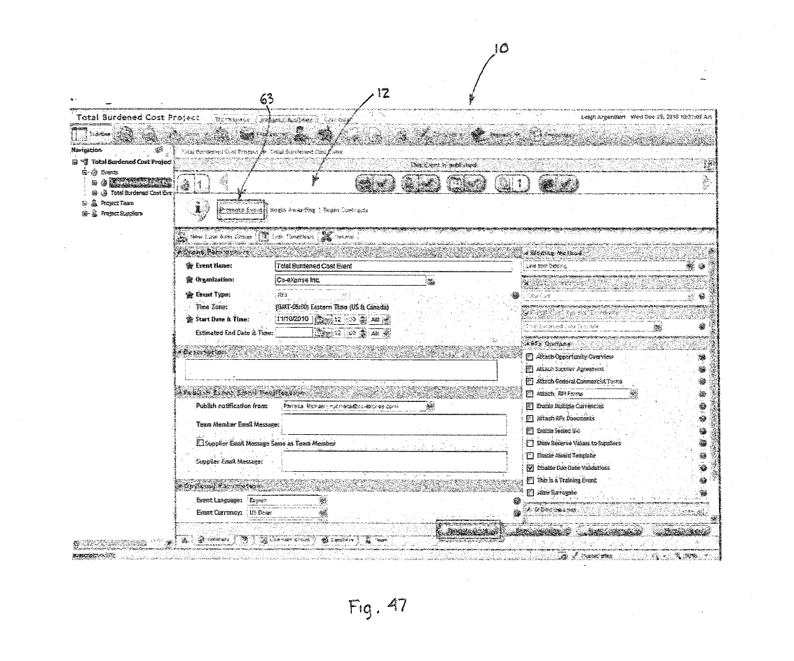

In a still further preferred and non-limiting embodiment of the present invention, the user interface 10 provides certain selectable options 12 to the user for use in promoting and further utilizing the event. As seen in FIG. 47, the user can select certain promotion options 63 in order to further configure and promote an event in a multiple-phase event. For example, the promotion options 63 can include the ability to name the event (e.g., “Best and Final Round), select the event type (e.g., Request for Quotation, Negotiation, etc.), where the event should be created or promoted (e.g., at the project level, in a new round of a negotiation, etc.), and what information or data should be copied to the new event (e.g., quote details, pricing, quotation forms, etc.) Still further, the user can decide which suppliers S and/or line items (or line item groups) should be included in the new event.

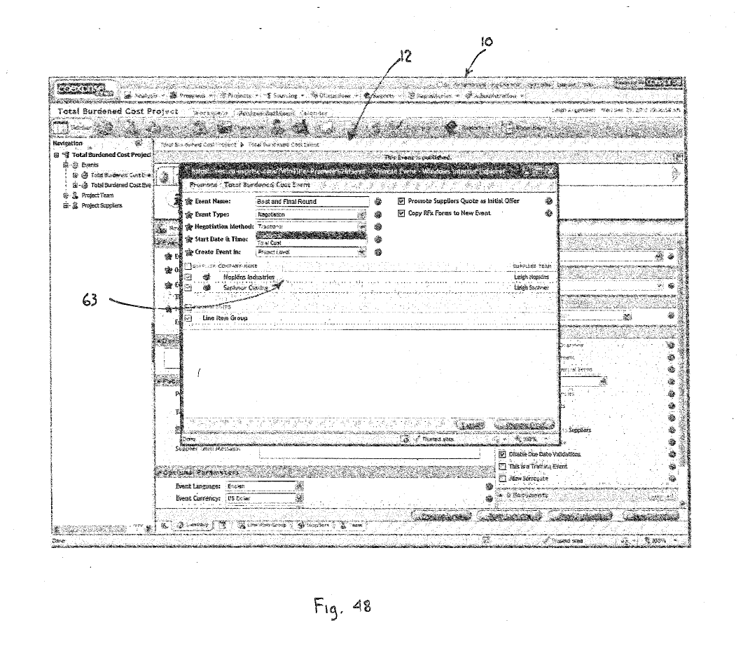

One example of this promotion functionality is illustrated in FIG. 48, where the user is presented of various promotion options 63. In this example, the user promotes the original event to a negotiation event, such that the user (e.g., the buyer B) can choose promotion options 63 relating to the event details (name, type, method, start date and time, creation level, suppliers, and line items) and which parts of the previous event should be promoted (or copied) forward, e.g., supplier's previous quotes as initial offer, quotation forms, new event type (traditional, total cost, etc.), or the like. In another example, if the buyer B chooses to promote an original event to a negotiation event, the buyer B can select the promotion options 63 that suit the data needs and infrastructure of the new event, e.g., quote details, pricing, quotation forms, etc. Still further, information and data from or responsive to a previous total cost template 14 (e.g., variables 18, supplier data 57, etc.) can be automatically promoted or copied to the new event, even if the new event utilizes a different total cost template 14.

Therefore, the present invention provides a promotion process that facilitates accurate transfer and usage of data between multiple, but related, events. This allows the buyer B to move information and data regarding an event from initial offer through best-and-final offers, down-selecting suppliers S, copying event data, and apply new negotiation methods to future events, e.g., the last quote becomes the first bid in an online auction. Accordingly, one total cost template 14 (or the data and information associated therewith) can be promoted forward, and links can be established between like variables 18 or fields to ensure accurate translation. This linking or mapping feature facilitates additional and beneficial functionality to the user or buyer B.

In order to effectively evaluate the total cost template 14 prior to publication and use, and as discussed above, the present invention provides for the intermediate evaluation of the total cost template 14 as it is being built. For example, the use of the symbols 30 across multiple sections 16 can be checked to ensure accuracy and avoid duplication. Any errors or deficiencies that are detected are then communicated to the user so that he or she can address them.

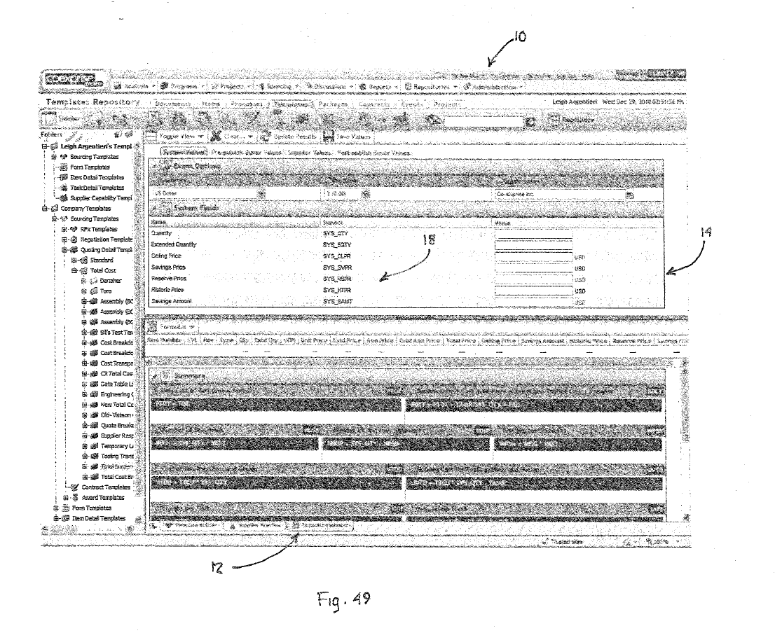

In addition, the present invention facilitates an understanding of how the total cost template 14 will work during an actual event through the “Template Evaluator” workspace. Accordingly, the user is provided with the ability to simulate an event using historic and/or fabricated data to assess how the total cost template 14 will flow and what results will be provided during an actual total cost event. In one example, and as illustrated in FIG. 49, the user or buyer B is provided with a selectable option 12 on the user interface 10 to engage in the evaluation of a total cost template 14. In this manner, the user can review the total cost template 14 without using it in an actual event to ensure that the correct information is being captured and/or analyzed. For example, while all of the formulae underlying the variables 18 may be correct, the buyer B may wish to alter a formula to ensure that the most meaningful information and data is captured from each supplier S. This facilitates a pre-publication troubleshooting function that assists in optimizing the total cost template 14. In particular, and in this example, the buyer B or user can review and analyze the system variables 48, summary variables 46, lookup table-based variables 40, global variables 38, calculated variables 32, or any other variable 18 of the total cost template 14 in a dedicated section of the system of the present invention.

In another preferred and non-limiting embodiment of the present invention, the user can configure the roles and abilities of the various members or groups of members of the buyer's team. In this embodiment, “subject matter expert” (SME) roles can be assigned to certain individuals that are (internal or external) users within the buyer B organization, e.g., roles can be established for modifications to global variables 38, certain sections of the total cost template 14, and the like. For example, the user can assign roles to ensure that only a specific person or group of people, e.g., the freight department, are able to complete certain freight-related variables 18 of the total cost template 14.

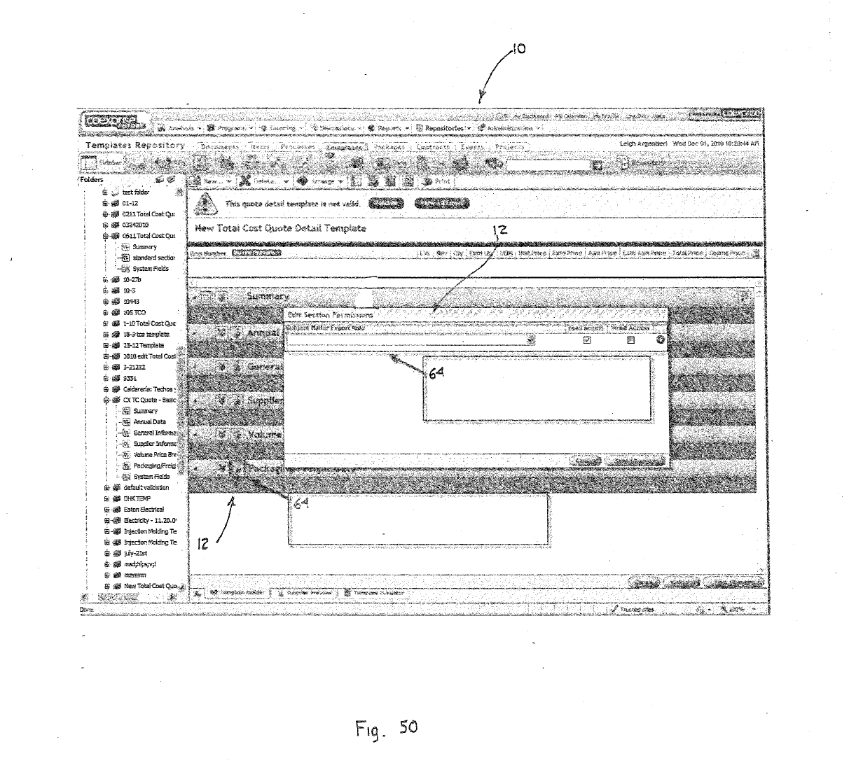

These SME roles can be added or modified in specified portions of the user interface 10, which may include a flat list of roles without hierarchy. Alternatively, the user may add or delete roles, or otherwise manage this assignment function. Further, a person can be assigned one or more roles based upon the person's responsibility or function for a given event or project. For example, as illustrated in FIG. 50, the user can assign SME roles to certain variables 18, e.g., global variables 38, lookup table-based variables 40, system variables 48, etc. These roles can be established for use within or external to the total cost template 14, and security options 64 can be provided to facilitate the management of these SME roles. Accordingly, these roles can be set for a project that includes multiple events, such that a person may have multiple or different roles for different events and activities. For example, a person may be assigned to a specific role or set of roles, and the ability to read and/or write certain variables 18, sections 16, etc. In this manner, the user can dynamically maintain information associated with the total cost template 14, and ensure that the appropriate personnel have the needed rights to update, maintain, and/or otherwise modify certain sections of the total cost template 14. In addition, the identification of the SME roles can be established by a third-party user, if desired, or the buyer B can identify a third party as SME, with specified roles and access. This is beneficial when a large buyer B company uses third-party service providers to collect, review, and/or maintain certain information or data sets. In addition, the creation, modification, or deletion of a global variable 38 may be provided to a specified SME or group of SMEs. Therefore, the SME can update information pertaining to a variable or table once, and this modification will be leveraged throughout the entire total cost template 14, or any total cost template 14 that utilizes the information in or generated by the global variable 38.

In a further preferred and non-limiting embodiment, the present invention provides the user or buyer B to surrogate a bid on behalf of a supplier S. Specifically, the user or buyer B can selectively supply information on behalf of a supplier S in an event, including a portion or all the responsive information that would have otherwise been provided directly by the supplier S. This surrogate quote can then be submitted on behalf of the supplier S. The user or buyer B also identifies the reason that the quote was submitted in this manner, e.g., technical difficulties, commodity manager/buyer received the quote via e-mail or mail, invited partner user absent and their delegate cannot access the application, supplier does not have access to the Internet, supplier refuses to access the application but the buyer wants the bid to be included, etc. Additionally, a notification, e.g., an e-mail, will be sent to the supplier S indicating that the surrogate quote/response has been successfully submitted in the event. This notification ensures that the supplier S recognizes that a response was submitted on their behalf.

In a still further preferred and non-limiting embodiment, the user is provided with selectable options 12 relating to the incumbency status of the supplier S. For example, the user can determine whether or not a supplier is an incumbent, and whether or not that incumbent supplier S will be a bidder in the event, or alternatively, simply used to compare previously-submitted supplier data 57 to the new supplier S information. Therefore, historical information and data can be used in analyzing future events with the same or similar suppliers S, or the same or similar line items.

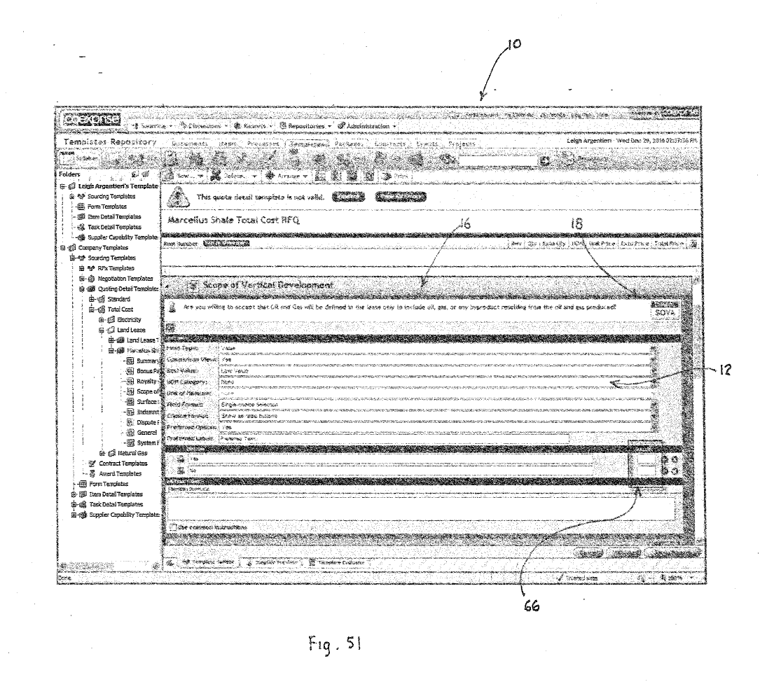

In another aspect of the present invention, and as illustrated in FIG. 51, the user or buyer B can weigh and score variables 18 (or the data associated therewith). In particular, both price and non-price factors and variables 18 and/or sections 16 can be assigned scores or otherwise weighted for use in the decision-making process. As seen in FIG. 51, the user can assign values 66 to the responses of the supplier S, i.e., supplier data 57. These values 66 can then be used in scoring a variable 18, weighing a variable 18, scoring a section 16, weighing a section 16, or otherwise distilling additional information based upon the supplier's response.

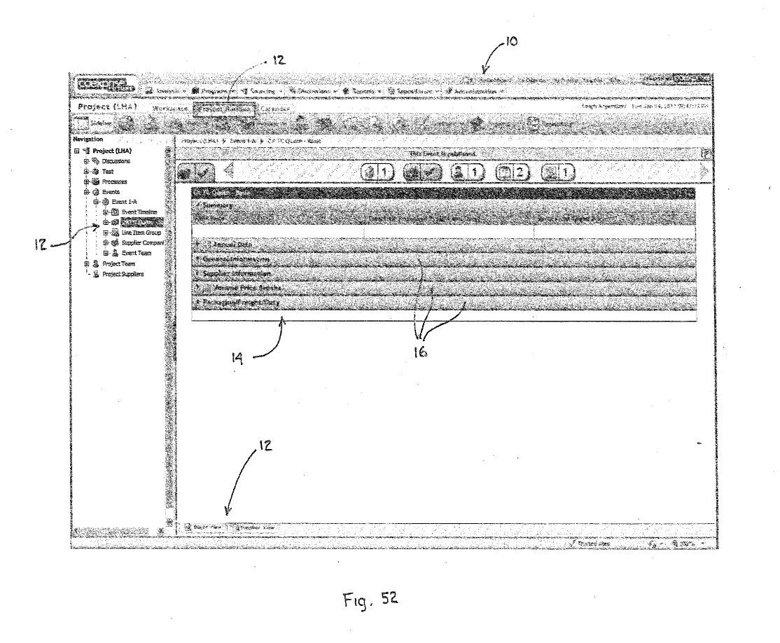

As used above, the user can be the buyer B, the supplier S, or any person affiliated or associated with the event or project management. Therefore, while the term “user interface” is used to refer to any of the various aspects and views of the presently-invented system and platform, multiple work spaces and/or views are provided to a user based upon his or her role in the overall process (and at different stages of the process). For example, a user may have selective access to build, review, or view any aspect of the project or event within a project. Further, the ultimate control of the event lies with the buyer B, who can selectively modify or provide certain permissions to other users. One example of a workspace on the user interface 10 is illustrated in FIG. 52. This workspace represents the “Project Builder” section, which allows the user to review any aspect of the project (e.g., event information, total cost template 14 information, item information, supplier S information, event team information, etc.) Further, this information can be viewed in either the “Buyer View” or “Supplier View” mode (such as through tabbed navigation), which configures the displayed information and data based upon the user affiliation, e.g., buyer B, supplier S, etc.

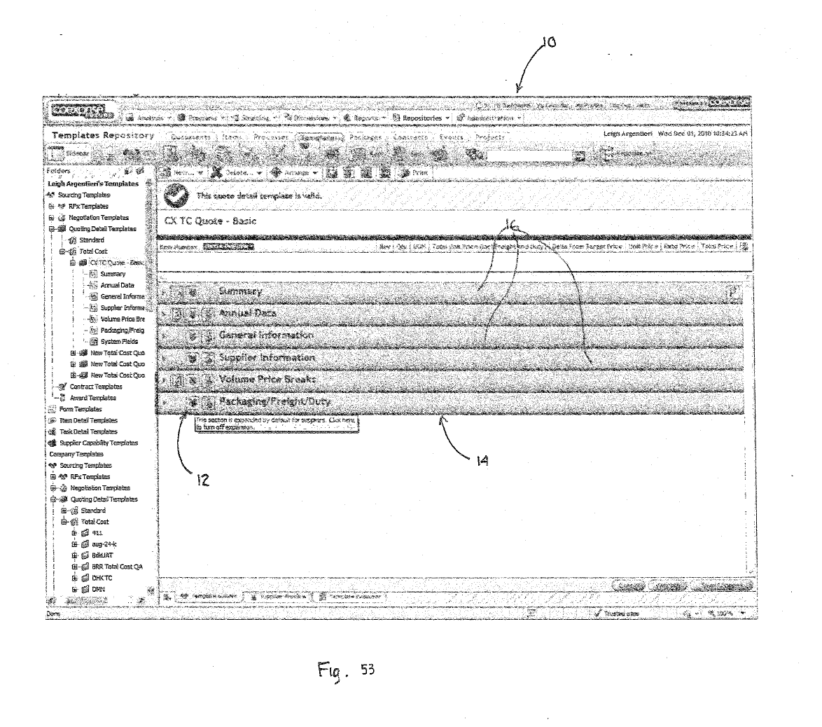

In another example of a workspace on the user interface 10, and as seen in FIG. 53, the user or buyer B can choose which sections 16 will be automatically expanded for the supplier S to view. These selectable options 12 can be configured in the “Template Builder” portion of this workspace on the user interface 10, and previewed in the “Supplier Preview” portion. Similarly, the total cost template 14 can be intermediately or finally evaluated and validated in the “Template Evaluator” portion. The user may navigate to these portions or sections as tabs or in any other known software navigation technique. Further, any selectable option 12 or data element can be in the form of a graphical icon, which is associated with an option, function, or selection.

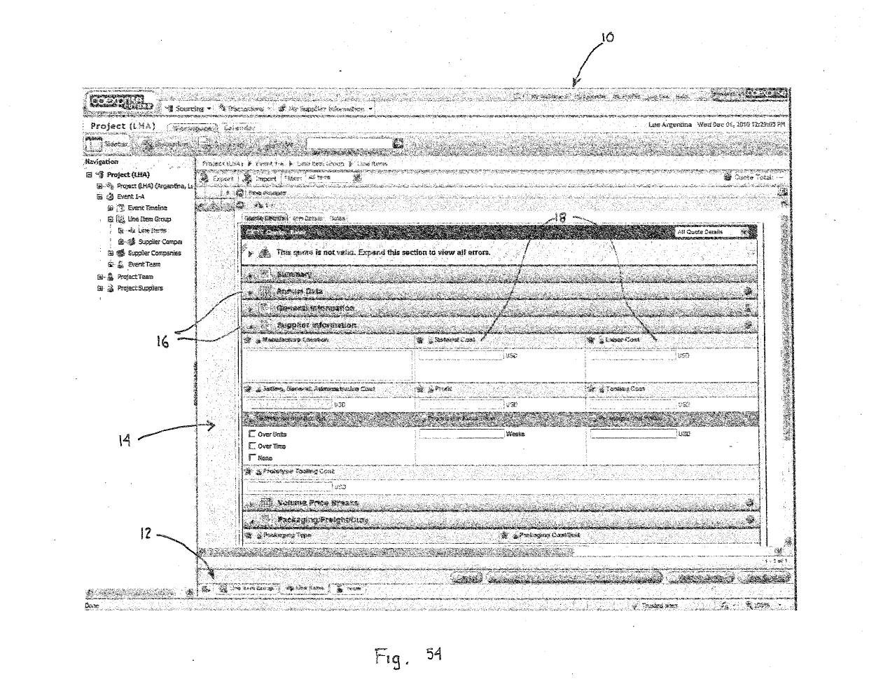

FIG. 54 illustrates another exemplary embodiment of a workspace on the user interface 10, which demonstrates the supplier's view of the total cost template 14 during the quotation process of the event. Again, any known navigational technique can be used to review and complete the total cost template 14. For example, the supplier S may view the total cost template 14 for a line item, a line item group, an assembly, a sub-assembly, or the like. Still further, the supplier S may be permitted to view the team members associated with the event or project, as needed.

In this manner, the present invention provides a total cost management system, method and apparatus that allow for the creation of a total cost template 14, the definition of a total cost unit price 50, the initiation of a total cost event, and the facilitation of a total cost event between buyers B and suppliers S. Again, while a standard cost event may be effective in capturing standard costs for a given part or item, the present invention provides the buyer B with the flexibility to capture and automatically roll-up collected information and data into a total cost of ownership determination, i.e., the total cost unit price 50. Accordingly, the present invention provides the much-needed flexibility to the buying organization to capture quote information with all the necessary costs and non-cost factors, which drives a better understanding of the impact to the “bottom line” of the buyer B.

The present invention provides for consistent enterprise-wide cost analysis, as well as buyer-defined reusable total cost templates 14, which ensures that all team members are working on the current version. The present invention provides for control of the variables 18 and how the information is captured, and allows the validation processes on both the buyer B side and the supplier S side, both intermediately and after completion. This ensures completeness and accuracy (within established range tolerances), as well as normalized and automated currency conversion to enable the buyers B to analyze supplier S bids on a “true” basis to determine the best cost alternatives. The present invention further provides the ability to leverage global cost tables, e.g., freight rates, to ensure consistency of specific cost elements across all total cost templates 14.

In another embodiment, the total cost template 14 is not visible within an event until it has been validated. Therefore, the user can continue to work on the total cost template 14 until complete, at which point the total cost template 14 would become available for use. While an incomplete or invalid total cost template 14 can be saved and viewed in the library, it cannot be chosen for use in an event until validated. An indication will be provided to the user as to which of the listed total cost templates 14 are valid (or invalid).

Still further, the present invention provides for the validation of the submitted quote or response of the supplier S. In particular, the proposed supplier S quotation or response is automatically reviewed prior to submission to the buyer B, and submission is prevented if the quote is missing one or more mandatory data points. The present invention is configured to provide the supplier S with information regarding the areas of the quotation or response that are deficient, such that the supplier S can correct and/or add the appropriate response data and again submit the response. Therefore, the validation process occurs at both the buyer B level (i.e., the total cost template 14) and the supplier S level (i.e., the quotation or response).

The total cost management system, method, and apparatus of the present invention further allows the buyer B to modify the total cost template 14 by adding specific variables 18, hiding specific variables 18, and/or removing specific variables 18. For example, if the event is for an indirect commodity, the total cost template 14 may not need the standard level and revision fields. Although such fields or variables 18 may be required in certain other events, e.g., a standard cost event, it may lead to confusion for a supplier S during the quoting process, as they do not have application in a non-direct material item. Further, buyers B may add any new summary variables 46 into the total cost template 14, such that the supplier S may be able to view the impact that the individually-entered cost factors have on the roll-up total cost unit price 50 (as associated with each specific supplier S, if more than one is involved in the event).

The total cost template 14 of the present invention also provides for a multi-level, multi-variable cost visibility, including integrated, flexible models that enable “drill-down” and “drill-up” techniques for analyzing cost breakdowns at a summary level, or to highlight variances on discrete cost elements for specific parts, e.g., raw materials, labor, overhead, tooling, shipping, etc. Accordingly, the total cost templates 14 generated in accordance with the present invention enable consideration of non-price or non-cost factors, such as critical non-price factors, e.g., lead time, manufacturing capabilities, quality certifications, adherence to specifications, supplier status, shipping information, inventory information, delivery information, shifts-per-day, raw materials, etc., which may be considered in award determinations. The present invention allows for this important information to be collected and analyzed for the supplier S, and/or compared across multiple suppliers S, to enable better sourcing decisions.

Still further, the total cost management system, method, and apparatus of the present invention allows for the above-discussed buyer B efficiency and control, such that procurement users realize greater productivity with automated template builder tools to reuse best practice, validated cost model formulae. Buyers B exercise full control over the process, benefitting from the ability to quickly compare normalized supplier S bids side-by-side, without having to reformat responses, as is required with known spreadsheet-based methods. Further, buyer-generated cost fields enable transformation of supplier S bids based on internal cost factors, such as transition costs for non-incumbent suppliers. Accordingly, the buyer B can analyze the information of a single supplier, or compare present and past information of the supplier.

Still further, the present invention provides for the use of local spreadsheet functionality in an online cost model structure. This permits the suppliers S to use familiar spreadsheet functionality for importing and exporting spreadsheet data and formulae. However, when such spreadsheet functionality is used within the context of the user interface 10 of the present invention, existing spreadsheet functionality is leveraged while eliminating spreadsheet inefficiencies and inaccuracies.

In this manner, the present invention provides a unique and innovative total cost management system, method, and apparatus that benefits both buyers B and suppliers S in all phases of the negotiation and sourcing process. Further, the present invention can be used to realize and review total cost information in a bill of material, multi-level bill of material, multiple, discrete bills of material, etc. In particular, the present invention can be used to dynamically roll-up the total costs to any level in the bill of material tree.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A total cost management system, comprising:
a user interface including:
(i) a plurality of selectable options to facilitate building at least one total cost template including at least one section having a plurality of variables associated therewith;
(ii) a plurality of selectable options to facilitate at least one of the following: creating, deleting, manipulating, configuring, changing, modifying, moving, or any combination thereof, at least one of the at least one section and at least one of the plurality of variables; and
(iii) at least one selectable option to define at least one total cost unit price for at least one of the following: at least one item, at least one group of items, at least one assembly, at least one group of assemblies, at least one sub-assembly, at least one group of sub-assemblies, at least one lot, at least one service, or any combination thereof;
wherein the at least one total cost unit price is defined by a formula including a plurality of the plurality of variables in the at least one section.

2. The total cost management system of claim 1, wherein at least one of the plurality of variables is assigned a symbol.

3. The total cost management system of claim 2, wherein the formula comprises an equation including at least one of the symbols.

4. The total cost management system of claim 1, wherein the at least one section comprises at least one of the following: a summary section, a standard section, a spreadsheet section, or any combination thereof.

5. The total cost management system of claim 2, wherein at least one of the plurality of variables is at least one of the following: a buyer-entered variable applicable to a plurality of suppliers, a buyer-entered variable applicable to a specified supplier, a supplier-entered variable, a calculated variable, a global variable, a system variable, a lookup table-based variable, a mandatory variable, a viewable variable, a post-bid variable, an external variable, an internal variable, a non-cost variable, a non-monetary variable, a monetized variable, or any combination thereof.

6. The total cost management system of claim 1, wherein at least one parameter is defined for at least one of the plurality of variables, the at least one parameter comprising at least one of the following: field type, comparison view, best value, currency, unit of measurement category, unit of measurement, field format, default value, decimal precision, minimum value, maximum value, instruction text, associated document, text length, default value, or any combination thereof.

7. The total cost management system of claim 1, wherein at least one of the plurality of variables is a calculated variable, the user interface including at least one selectable option for at least one of the following: naming the variable, assigning a symbol, defining an equation, defining a function, or any combination thereof.

8. The total cost management system of claim 7, wherein the equation comprises at least one selected symbol and at least one mathematical operator or function.

9. The total cost management system of claim 7, wherein the defined function comprises a lookup function that parses a separate table for at least one match.

10. The total cost management system of claim 1, wherein at least one of the plurality of variables includes a list of a plurality of choices, wherein at least one of the plurality of choices is assigned a value.

11. The total cost management system of claim 1, wherein at least one of the plurality of variables is a post-bid variable that is determined after at least one other variable is determined based at least in part upon data obtained from at least one supplier.

12. The total cost management system of claim 1, wherein at least one of the plurality of variables is a global variable, which is at least one of the following: a supplier-specific variable, a buyer-specific variable, a calculated variable, a lookup table-based variable, or any combination thereof.

13. The total cost management system of claim 12, wherein the global variable comprises a configurable table of data defined by the user.

14. The total cost management system of claim 1, wherein the at least one section is a spreadsheet section comprising a plurality of configurable cells for defining at least one of the plurality of variables.

15. The total cost management system of claim 1, further comprising an interface having a plurality of selectable options for generating at least one view presenting data associated with at least one of the plurality of variables.

16. The total cost management system of claim 1, further comprising at least one selectable option for validating at least a portion of the at least one total cost template.

17. The total cost management system of claim 1, further comprising at least one selectable option to simulate an event utilizing the at least one total cost template.

18. The total cost management system of claim 1, wherein the at least one section is a summary section including at least one summary variable that is automatically determined at least partially based upon at least one other variable of the at least one total cost template.

19. A computer-implemented method for initiating a total cost event between at least one buyer and at least one supplier, comprising:
defining at least one parameter of the total cost event;
selecting at least one total cost template having at least one section including a plurality of variables associated therewith, the at least one total cost template associated with at least one of the following: at least one item, at least one group of items, at least one assembly, at least one group of assemblies, at least one sub-assembly, at least one group of sub-assemblies, at least one lot, at least one service, or any combination thereof;
selecting at least one supplier for participation in the total cost event; and
initiating the total cost event by presenting at least a portion of the plurality of variables to the at least one supplier;
wherein the total cost event is associated with at least one total cost unit price for at least one of the following: at least one item, at least one group of items, at least one assembly, at least one group of assemblies, at least one sub-assembly, at least one group of sub-assemblies, or any combination thereof and wherein the at least one total cost unit price is defined by a formula including a plurality of the plurality of variables in the at least one section.

20. The computer-implemented method of claim 19, further comprising defining at least one of the following for the total cost event: item data, level data, revision data, description data, quantity data, extended quantity data, unit of measurement data, extended price data, assembly labor price data, extended assembly labor price data, total price data, ceiling price data, savings price data, reserve price data, historical price data, or any combination thereof.

21. The computer-implemented method of claim 19, further comprising, prior to initiating the total cost event, defining at least one of the following: a buyer-entered variable applicable to a plurality of suppliers, a buyer-entered variable applicable to a specified supplier, a supplier-entered variable, a calculated variable, a global variable, a system variable, a lookup table-based variable, a mandatory variable, a calculated variable, a viewable variable, a post-bid variable, an external variable, an internal variable, a non-price variable, a non-monetary variable, a monetized variable, or any combination thereof.

22. The computer-implemented method of claim 19, further comprising, prior to initiating the total cost event, notifying a user about at least one aspect of at least one of the following: at least one parameter of the total cost event, at least one cost template, at least one section, at least one variable, or any combination thereof.

23. The computer-implemented method of claim 19, further comprising associating at least one document with at least one of the plurality of variables of the total cost template.

24. The computer-implemented method of claim 19, further comprising generating at least one configurable report presenting data associated with at least one of the plurality of variables.

25. The computer-implemented method of claim 19, further comprising validating at least a portion of supplier data responsive to the at least one total cost template prior to facilitating submission of the supplier data to the buyer.

26. The computer-implemented method of claim 19, further comprising generating at least one notification indicating at least one of the following: at least one supplier has submitted supplier data responsive to the at least one total cost template, at least one supplier will not be submitting supplier data responsive to the at least one total cost template, or any combination thereof.

27. The computer-implemented method of claim 19, further comprising:
creating a subsequent event; and
mapping at least one variable, or data associated therewith, between the total cost event and the subsequent event.

28. The computer-implemented method of claim 19, further comprising analyzing at least one variable, or data associated therewith, to determine the best value to the at least one buyer.

29. A computer-implemented method of facilitating a total cost event between at least one buyer and at least one supplier, comprising:
transmitting, to the at least one supplier, at least one total cost template having at least one section including a plurality of variables associated therewith, the at least one total cost template associated with at least one of the following: at least one item, at least one group of items, at least one assembly, at least one group of assemblies, at least one sub-assembly, at least one group of sub-assemblies, at least one lot, at least one service, or any combination thereof, wherein the total cost event is associated with at least one total cost unit price for at least one of the following: at least one item, at least one group of items, at least one assembly, at least one group of assemblies, at least one sub-assembly, at least one group of sub-assemblies, or any combination thereof and wherein the at least one total cost unit price is defined by a formula including a plurality of the plurality of variables in the at least one section;
receiving at least one at least partially completed total cost template from the at least one supplier; and
generating at least one configurable view presenting at least one of the plurality of variables as completed by the at least one supplier.

30. The computer-implemented method of claim 29, wherein the at least one total cost template transmitted to the at least one supplier is configured for completion directly by the at least one supplier.

31. The computer-implemented method of claim 29, wherein the at least one total cost template transmitted to the at least one supplier is configured for completion through importing data from a separate source.

32. The computer-implemented method of claim 29, wherein the at least one total cost template transmitted to the at least one supplier is configured for completion through the exporting at least a portion of the at least one total cost template into a separate software program.

33. The computer-implemented method of claim 28, wherein the at least one generated view indicates the best value for at least one of the plurality of variables.

34. The computer-implemented method of claim 28, wherein the at least one generated view presents data associated with at least a portion of the total cost template.

35. The computer-implemented method of claim 28, wherein the at least one generated view presents a side-by-side comparison of data associated with at least one of the plurality of variables.

36. The computer-implemented method of claim 28, wherein the at least one generated view presents a graphical representation of data associated with at least one of the plurality of variables.

37. The computer-implemented method of claim 28, further comprising exporting at least a portion of at least one completed total cost template into a separate software program.
